(19) United States
(12) Patent Application Publication
(10) Pub. No.: US 2023/0095396 A1
(43) Pub. Date: Mar. 30, 2023

(54) METHOD OF PRINTING

(71) Applicant: HEWLETT-PACKARD DEVELOPMENT COMPANY, L.P., Spring, TX (US)

(72) Inventors: Mazi Bar, Netanya (IL); Alex Trubnikov, Netanya (IL); Eytan Cohen, Netanya (IL); Kfir Dar, Netanya (IL); Kobi Cohen, Netanya (IL)

(21) Appl. No.: 17/911,404

(22) PCT Filed: Apr. 2, 2020
(86) PCT No.: PCT/US2020/026441

§ 371 Date: Sep. 13, 2022

(51) Int. Cl. C09D 11/54; C09D 11/322; C09D 11/40

(52) U.S. Cl. CPC C09D 11/54; C09D 11/322; C09D 11/40

(57) ABSTRACT

A method of printing is described. The method comprises applying a fixer composition onto a substrate. The fixer composition comprises a polyvalent metal salt, a cationic polymer, and a liquid vehicle, with a ratio of polyvalent metal salt to cationic polymer in a range of 1:1 to 3.5:1. The method comprises applying an ink composition onto the fixer composition; and applying an over-print varnish composition onto the ink composition. A printed article and a print set are also described.

### BACKGROUND

Inkjet printing involves the deposition of ink onto a substrate by jetting the ink through a print nozzle supplied by an ink cartridge.

Fixer fluid compositions can be used as pre-treatments prior to ink deposition, and over-print varnish compositions can be used as post-treatments.

### BRIEF DESCRIPTION OF THE DRAWINGS

FIG. 1 shows the gloss levels of example formulations of the present disclosure.

FIG. 2 shows coalescence levels of example formulations of the present disclosure.

### DETAILED DESCRIPTION

Before particular embodiments of the present method and other aspects are disclosed and described, it is to be understood that the present method and other aspects are not limited to the particular process and materials disclosed herein as such may vary to some degree. It is also to be understood that the terminology used herein is used for the purpose of describing particular embodiments only and is not intended to be limiting, as the scope of the present method and other aspects will be defined only by the appended claims and equivalents thereof.

In the present specification, and in the appended claims, the following terminology will be used:

The singular forms “a”, “an” and “the” include plural referents unless the context clearly dictates otherwise. Thus, for example, reference to “a pigment” includes reference to one or more of such materials.

The terms “about” and “approximately” when referring to a numerical value or range is intended to encompass the values resulting from experimental error that can occur when taking and/or making measurements.

Unless otherwise stated, references herein to “wt. %” of a component are to the weight of that component as a percentage of the whole composition comprising that component. For example, references herein to “wt. %” of, for example a solid material such as a pigment or latex polymer dispersed in a liquid composition are to the weight percentage of those solids in the composition, and not to the amount of that solid as a percentage of the total non-volatile solids of the composition.

As used herein, the term “particle size” is a reference to the mean particle size by volume, as measured using laser diffraction techniques using diffractometers such as the Malvern Mastersizer, or Microtrac or Nanotrac diffractometers.

As used herein, references to “fixing fluid”, “optimiser fluid”, “pre-treat fluid”, “post-treat fluid”, “overcoat fluid”, or to compositions or formulations with the same names, are to liquid compositions that are intended to be printed before, simultaneously with, or after an inkjet ink composition has been printed onto a media substrate. Such fluids and compositions are generally known in the art, and are known generally to be free of colourant (i.e. are colourless), but can contain “crashing agents” to promote colourant aggregation and thereby reduce bleed.

As used herein, “ink vehicle” or “liquid vehicle” is defined to include liquid compositions that can be used to carry components such as pigments, to a substrate. Liquid vehicles are well known in the art, and a wide variety of liquid vehicle components may be used in accordance with examples of the present ink set and method. Such liquid vehicles may include a mixture of a variety of different agents, including without limitation, surfactants, co-solvents, buffers, biocides, viscosity modifiers, sequestering agents, stabilising agents, and water. Though not liquid per se, the liquid vehicle can also carry other solids, such as polymers, UV curable materials, plasticisers, salts, etc.

As used herein, “pigment” refers to colour imparting particulates that may be suspended in an ink vehicle. Pigments that can be used include self-dispersed pigments and non self-dispersed dispersed pigments. Self-dispersed pigments include those that have been chemically surface modified with a charge or a polymeric grouping. This chemical modification aids the pigment in becoming and/or substantially remaining dispersed in a liquid vehicle. The pigment can also be a non self-dispersed pigment that utilises a separate and unattached dispersing agent (which can be a polymer, an oligomer, or a surfactant, for example) in the liquid vehicle or physically coated on the surface of the pigment. The dispersing agent can be non-ionic or ionic, anionic or cationic. If the dispersing agent is anionic, possessing carboxy groups, for example, the pigment is referred to as an “anionic pigment dispersion”.

As used herein, the term “set” refers to a set of inks, whether packaged or made available as part of a set, or packaged and made available separately for use with other members of the set.

As used herein, the term “wet-on-wet printing” refers to a printing method in which two or more print compositions are printed one on top of the other without drying of the underlying print layer before the overlying print layer is printed. As used herein, the term “wet-on-dry printing” refers to a printing method in which two or more print compositions are printed one on top of the other with drying of the underlying print layer before the overlying print layer is printed.

As used herein, “latex”, “latex polymer”, “latex particulates” or “latex particles” refer to the polymeric masses synthesised from individual monomers, which can be dispersed in a liquid vehicle forming a latex dispersion. The term “latex” generally refers to liquid and polymeric particles that are dispersed within the liquid. However, when a latex (i.e. a latex dispersion including latex polymer particles) is formulated within an ink, the liquid becomes part of the liquid vehicle of the ink, and thus, latex polymer can be described based on the latex particle or latex polymer solids that remain dispersed in the liquid vehicle. A latex may be a liquid suspension comprising a liquid (such as water and/or other liquids) and polymeric particulates from 20 nm to 500 nm (preferably from 100 nm to 300 nm) in size. Typically, the polymeric particulate can be present in the liquid at from 0.5 wt. % to 35 wt. %. Such polymeric particulates can comprise a plurality of monomers that are typically randomly polymerised, and can also be crosslinked. Additionally, in one embodiment, the latex component can have glass transition temperature from about −20° C. to +100° C.

As used herein, “co-polymer” refers to a polymer that is polymerised from at least two monomers.

A certain monomer may be described herein as constituting a certain weight percentage of a polymer. This indicates that the repeating units formed from the said monomer in the polymer constitute said weight percentage of the polymer.

The term “monomer emulsion” refers to an organic monomer or monomer that is emulsified in an aqueous or water phase. Once the organic monomer or monomer mix is polymerised, a latex polymer dispersion is formed.

The term “latex polymer dispersion” or “latex dispersion” includes both latex particulates as well as the aqueous medium in which the latex particulates are dispersed. More specifically, a latex dispersion is a liquid suspension comprising a liquid (such as water and/or other liquids) and polymeric particulates from 20 nm to 500 nm (preferably from 100 nm to 300 nm) in size, and having a weight average molecular weight from about 10,000 Mw to 2,000,000 Mw (preferably from about 40,000 Mw to 100,000 Mw). Such polymeric particulates can comprise a plurality of monomers that are typically randomly polymerised, and can also be crosslinked. When crosslinked, the molecular weight can be even higher than that cited above.

The term “(meth)acrylate” is well understood in the art to refer to both acrylates and methacrylates. For example, “cyclohexyl (meth)acrylate” refers to cyclohexyl acrylate and/or cyclohexyl methacrylate. Likewise, the term “cycloaliphatic (meth)acrylate monomer” denotes a cycloaliphatic acrylate monomer and/or a cycloaliphatic methacrylate monomer; and the term “aromatic (meth)acrylate monomer” denotes an aromatic acrylate monomer and/or an aromatic methacrylate monomer.

The term “(meth)acrylamide” is well understood in the art to refer to both acrylamides and methacrylamides. For example, the term “cycloaliphatic (meth)acrylamide monomer” denotes a cycloaliphatic acrylamide monomer and/or a cycloaliphatic methacrylamide monomer; and the term “aromatic (meth)acrylamide monomer” denotes an aromatic acrylamide monomer and/or an aromatic methacrylamide monomer.

Concentrations, amounts, and other numerical data may be presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt. % to approximately 20 wt. % should be interpreted to include not only the explicitly recited concentration limits of 1 wt. % to approximately 20 wt. %, but also to include individual concentrations such as 2 wt. %, 3 wt. %, 4 wt. %, and sub-ranges such as 5 wt. % to 10 wt. %, 10 wt. % to 20 wt. %, etc.

In the following description, for purposes of explanation, numerous specific details are set forth in order to provide a thorough understanding of the present print set, printed article and method for printing. It will be apparent, however, to one skilled in the art, that the present method maybe practiced without these specific details. Reference in the specification to “one example” or “an example” means that a particular feature, structure, or characteristic described in connection with the example is included in at least one example. The appearance of the phrase “in one example” in various places in the specification are not necessarily all referring to the same example.

Unless otherwise stated, any feature described herein can be combined with any aspect or any other feature described herein.

Wet-on-wet printing may be desirable, for example, so that in-line printing can be performed. Wet-on-wet printing could also eliminate the need for a separate drying step before application of an over-print composition, reducing the size of the apparatus and cost of running it. However, wet-on-wet printing can result in loss of high gloss, durability and acceptable levels of coalescence when printing over-print varnish compositions onto ink compositions printed on absorbing (e.g. porous) substrates.

Therefore, the present inventors have sought to provide fixer fluid formulations, for use in the method of wet-on-wet application of over-print varnish compositions onto ink compositions printed on substrates. The present inventors have found that fixer fluid compositions in accordance with the present disclosure are particularly effective at affording printed articles with excellent gloss levels, durability and acceptable levels of coalescence when printing over-print varnish compositions onto said substrates in a wet-on-wet application method.

In an aspect there is provided a method of printing comprising: applying a fixer composition onto a substrate, the fixer composition comprising a polyvalent metal salt, a cationic polymer, and a liquid vehicle, wherein the ratio of the polyvalent metal salt to cationic polymer is in a range of 1:1 to 3.5:1; applying an ink composition onto the fixer composition; and applying an over-print varnish composition onto the ink composition.

In a further aspect there is provided a printed article comprising: a substrate; a fixer composition disposed on the substrate, wherein the fixer composition comprises a polyvalent metal salt and a cationic polymer, wherein the ratio of the polyvalent metal salt to cationic polymer is in a range of 1:1 to 3.5:1; an ink composition disposed on the fixer composition; and an over-print varnish composition disposed on the ink composition.

In a further aspect there is provided a print set comprising: a fixer fluid composition comprising: a polyvalent metal salt, a cationic polymer, and a liquid vehicle; wherein the ratio of polyvalent metal salt to cationic polymer is in a range of 1:1 to 3.5:1; an ink composition; and an over-print varnish composition.

### Method of Printing

In some examples, a method of inkjet printing is described, comprising: applying a fixer composition onto a substrate, the fixer composition comprising a polyvalent metal salt, a cationic polymer, and a liquid vehicle, wherein the ratio of polyvalent metal salt to cationic polymer is in a range of 1:1 to 3.5:1; applying an ink composition onto the fixer composition; and applying an over-print varnish composition onto the ink composition.

In some examples, the method is a wet-on-wet method, in which the ink composition is applied onto the fixer composition while the fixer composition is still wet. In some examples, the method is a wet-on-wet method, in which the over-print varnish composition is applied onto the ink composition while the fixer composition and/or the ink composition are still wet. In some examples, the method is a one-pass wet-on-wet printing method. In some examples, the wet-on-wet printing method comprises a delay of no more than about 5 seconds between each printing stage, for example no more than about 4 seconds, for example no more than about 3 seconds, for example no more than about 2 seconds, for example no more than about 1 second, for example no more than about 0.5 seconds, for example no more than about 0.1 second.

In some examples, the fixer fluid composition is as described herein. The fixer fluid composition is suited for use as a pre-treatment undercoat to the printed ink composition. In one example, the fixer fluid composition is printed as a pre-treatment onto the substrate before the ink composition is printed. In some examples, the fixed fluid composition is applied to the substrate using an inkjet printer.

In some examples, the substrate is a porous substrate, for example paper, cardboard, for example corrugated cardboard. The nature of the substrate will depend on the end application of the printed article, i.e. the user requirements.

In some examples, the ink composition is as described herein. In some examples, the ink composition is an inkjet composition, for example a thermal inkjet composition, or a piezo inkjet composition. In some examples, the inkjet composition is applied onto the fixer composition on the substrate, and is subsequently printed over with the over-print varnish composition.

In some examples, the over-print varnish composition is as described herein. The over-print varnish composition is suited for use as a post-treatment overcoat to the printed ink composition. In one example, the over-print varnish composition is printed as an overcoat onto the substrate after the ink composition has been printed.

In one example, the amount of fixer fluid composition relative to ink composition printed onto the substrate may be less than about 25%, expressed as a volume percentage. In other words, a ratio of 25% is equivalent to 4 volume parts ink to every one volume part of fixer composition. In one example, the amount of fixer fluid composition relative to ink composition printed onto the substrate may be less than 20%, for example less than about 18%, for example less than about 16%, for example less than about 14%, for example less than about 12%, for example less than about 10%, for example less than about 8%, for example less than about 6%, for example less than about 5%, expressed as a volume percentage.

In one example, the amount of fixer fluid composition relative to ink composition printed onto the substrate may be greater than about 5%, expressed as a volume percentage. In one example, the amount of fixer fluid composition relative to ink composition printed onto the substrate may be greater than 6%, for example greater than about 8%, for example greater than about 10%, for example greater than about 12%, for example greater than about 14%, for example greater than about 16%, for example greater than about 18%, for example greater than about 20%, for example greater than about 25%, expressed as a volume percentage.

In some examples, the amount of over-print varnish composition printed over the ink is such that a coverage of at least 5 grams per square meter (gsm) is achieved. In some examples, the amount of over-print varnish composition printed over the ink is at least 5.1 gsm, for example at least 5.2 gsm, for example at least 5.3 gsm, for example at least 5.4 gsm, for example at least 5.5 gsm, for example at least 6 gsm, 7 gsm, 8 gsm, 9 gsm or to about 10 gsm.

In some examples, the method further comprises a drying step, following application of the over-print varnish composition. In some examples, the drying step comprises application of heat. In some examples, the drying step comprises application of a flow of air, causing evaporation. In some examples the drying step comprises passing the printed article resulting from the method to a source of heat. The source of heat may be for example a heater, for example an IR heater.

### Fixer Fluid Composition

In one example, an inkjet fixer fluid composition comprises: a polyvalent metal salt, a cationic polymer, and a liquid vehicle, wherein the ratio of polyvalent metal salt to cationic polymer is in a range of 1:1 to 3.5:1. In one example, the inkjet fixer fluid composition is substantially free of colourant. By substantially free of colourant, it will be understood that the composition appears colourless to the unaided eye under normal light and is thus distinguished from an inkjet ink composition comprising colourant such as cyan, magenta, yellow or black. In one example, the composition is an aqueous solution, substantially free of any dispersed solids.

### Polyvalent Metal Salt

In one example, the fixer fluid composition comprises a polyvalent metal salt. The polyvalent metal salt may be any salt of a metal ion wherein the metal ion carries more than one charge, for example a salt of a divalent metal ion, a salt of a trivalent metal ion, a salt of a tetravalent metal ion and so on. In some examples, the metal ion is selected from the group consisting of Na⁺, K⁺, Mg²⁺, Ca²⁺, Ba²⁺, Al³⁺. In some examples, the water-soluble polyvalent metal salt comprises a mixture of two or more water-soluble polyvalent metal salts.

In one example, the metal ion is divalent calcium. In some examples, the calcium-containing polyvalent metal salt is an organic calcium salt, an inorganic calcium salt, or a mixture thereof. In some examples, the calcium-containing metal salt is a cationic mixture of organic and inorganic calcium salt. In some examples, the calcium-containing metal salt can be a mixture of a metal carboxylate salt and of a water-soluble polyvalent metal salt comprising calcium.

As a metal carboxylate salt, it is meant herein a metal salt composed of a multivalent metallic ion and of a carboxylate ion. The metal carboxylate salt can be selected from the group consisting of calcium propionate salt, calcium acetate salt and calcium butyrate salt. In some examples, the metal carboxylate salt is calcium propionate. As water-soluble polyvalent metal salt, it is meant herein a water-soluble polyvalent metal salt, for example calcium. Examples of such a compound include: calcium nitrate (Ca(NO₃)₂), calcium chloride (CaCl₂), calcium hydroxide (Ca(OH)₂) and calcium acetate (Ca(CH₃COO)₂). In some examples, the water-soluble polyvalent metal salt is calcium nitrate.

In some examples, the polyvalent metal salt consists of calcium propionate and calcium nitrate. In some examples, the fixer fluid composition includes a polyvalent metal salt that is a cationic calcium-containing polyvalent metal salt consisting of calcium propionate and calcium nitrate.

The fixer fluid composition can include a polyvalent metal salt consisting of calcium propionate and calcium nitrate. The calcium propionate may be present in an amount ranging from 0 wt. % to about 3 wt. % based on a total wt. % of the fixer fluid composition, while the calcium nitrate may be present in an amount ranging from about 0 wt. % to about 10 wt. % based on the total wt. % of the fixer fluid composition. In some examples, the two salts are present in a ratio that is in a range of 1:1 to 3:1 (calcium nitrate:calcium propionate). In some examples, the ratio is 8:2.8 (calcium nitrate:calcium propionate).

In some examples, these two calcium salts can be used individually, as mentioned above, and the result is substantially the same as the combination. If one of the two calcium salts is 0 wt. %, the other of the calcium salts can be at its maximum weight percent.

### Cationic Polymer

In one example, the fixer fluid composition comprises a water-soluble cationic polymer. The water-soluble cationic polymer may be present in an amount of less than about 10 wt. %. In one example the fixer fluid composition comprises a cationic polymer present in an amount of less than about 8 wt. %, for example less than about 6 wt. %, for example less than about 5 wt. %, for example less than about 4 wt. %, for example less than about 3 wt. %, for example less than about 2.5 wt. %, for example less than about 2 wt. %, for example less than about 1.5 wt. %, for example less than about 1 wt. %, for example to about 0.5 wt. %, based on the total weight of the composition.

In one example, the fixer fluid composition comprises a cationic polymer present in an amount of greater than about 0.5 wt. %. In one example, the fixer fluid composition comprises a cationic polymer present in an amount of greater than about 1 wt. %, for example greater than about 1.5 wt. %, for example greater than about 2 wt. %, for example greater than about 2.5 wt. %, for example greater than about 3 wt. %, for example greater than about 3.5 wt. %, for example greater than about 4 wt. %, for example greater than about 5 wt. %, for example greater than about 6 wt. %, for example greater than about 8, for example to about 10 wt. % based on the total weight of the composition.

Many different types of cationic polymer are known in the art to be suitable for use in fixer fluid compositions. In one example, the cationic polymer comprises one or more of a quaternary amine, a polyamine, such as a polyethyleneimine (“PEI”), a polyguanidine cationic polymer, a water-soluble cationic dendrimer, a polyallylamine, a poly diallyl dimethyl ammonium chloride, or a polyvinyl pyrrolidone. Suitable polyamines include those derived from epichlorohydrin and dimethyl amine, for example copolymers of epichlorohydrin and dimethyl amine. Suitable polyguanidine cationic polymers may include, but are not limited to, hexamethylene guanide (“HMG”), a polymer of hexamethylene biguanide (“HMB”), and a copolymer of HMB and HMG. PHMB is available from Avecia™ Ltd. (Manchester, England). Suitable cationic polymers may include, but are not limited to, those obtainable from SNF Group such as Floquat™ 4150 (or Floquat™ 2350), a linear polyamine, as well as structured polyamines such as Floquat™ 2999, 2949, 3249, 2370 and 2273. The polyamine may be 2-Propen-1-aminium, N,N-dimethyl-N-2-propen-1-yl-, chloride, homopolymer. Other suitable cationic polymers include Raycat 78 and RayCat 100, cationic acrylic emulsion polymers from Speciality Polymers, Inc.

### Ratio of Polyvalent Metal Salt to Cationic Polymer

The present inventors have found that fixer fluid compositions may be formed by providing a composition comprising a polyvalent metal salt and a cationic polymer in particular ratios.

In some examples, the ratio of polyvalent metal salt to cationic polymer by weight is greater than about 1:1. In some examples, the ratio of polyvalent metal salt to cationic polymer by weight is about 1.2:1 or greater, for example about 1.4:1 or greater, about 1.5:1 or greater, about 1.7:1 or greater, about 1.8:1 or greater, about 2:1 or greater, about 2.2:1 or greater, about 2.5:1 or greater, about 2.7:1 or greater, about 3:1 or greater, about 3.2:1 or greater, about 3.4:1 or greater, to about 3.5:1.

In some examples the ratio of polyvalent metal salt to cationic polymer by weight is less than about 3.5:1. In some examples, the ratio of polyvalent metal salt to cationic polymer by weight is about 3.4:1 or less, about 3.2:1 or less, about 3:1 or less, about 2.7:1 or less, about 2.5:1 or less, about 2.2:1 or less, about 2:1 or less, about 1.8:1 or less, about 1.7:1 or less, about 1.5:1 or less, about 1.4:1 or less, about 1.2:1 or less, or about 1:1 or less.

In some examples, the ratio of polyvalent metal salt to cationic polymer by weight is in the range of greater than about 1:1 to about 3.5:1, for example in the range of greater than about 1.2:1 to about 3.4:1. In some examples, the ratio of polyvalent metal salt to cationic polymer by weight is in the range of about 1.4:1 to about 3.2:1, for example about 1.5:1 to about 3:1, about 1.7:1 to about 2.7:1, or about 1.8:1 to about 2.5:1.

### Liquid Vehicle

In one example, the inkjet fixer fluid composition comprises a liquid vehicle. The liquid vehicle may be an aqueous liquid vehicle, i.e. it comprises water.

In some examples, the liquid vehicle comprises a solvent other than water or in addition to water. In some examples, the solvent is selected from an aliphatic alcohol, for example a primary aliphatic alcohol, a secondary aliphatic alcohol or a tertiary aliphatic alcohol. The aliphatic alcohol may be a diol. In some examples, the solvent is an aliphatic alcohol containing 10 carbons or less, for example 8 carbons or less, or 6 carbons or less. In some examples, the solvent is an aliphatic alcohol being a diol containing 10 carbons or less, for example 8 carbons or less or 6 carbons or less.

In some examples, the solvent is selected from the group comprising 1,2-propanediol, 1,2-butanediol, ethylene glycol, tetraethylene glycol, 2-methyl-2,4-pentanediol, 1,3-butanediol, 2-methyl-1,3-propanediol and 1,3-propanediol. In some examples, the solvent is selected from the group comprising 1,2-propanediol, 1,2-butanediol, ethylene glycol, tetraethylene glycol, 2-methyl-2,4-pentanediol and 1,3-butanediol. In some examples, the solvent is selected from the group comprising 1,2-propanediol, 1,2-butanediol, ethylene glycol, tetraethylene glycol, 2-methyl-2,4-pentanediol, 1,3-butanediol, 2-methyl-1,3-propanediol and 1,3-propanediol. In some examples, the solvent is selected from the group comprising 1,2-propanediol, 1,2-butanediol, ethylene glycol, tetraethylene glycol, 2-methyl-2,4-pentanediol and 1,3-butanediol. In some examples, the solvent is tetraethylene glycol.

In some examples, the fixer fluid composition comprises at least about 2 wt. % of the solvent by total weight of the composition, for example at least about 10 wt. %, or at least about 15 wt. % by total weight of the composition.

In some examples, the fixer fluid composition comprises less than about 40 wt. % of the solvent by total weight of the composition, for example less than about 30 wt. %, or less than about 20 wt. % by total weight of the composition.

In some examples, the fixer fluid composition comprises the solvent in an amount of from about 2 wt. % to about 40 wt. % by total weight of the composition, for example from about 5 wt. % to about 30 wt. %, about 7 wt. % to about 20 wt. %, or from about 8 wt. % to about 15 wt. % by total weight of the composition.

In some examples, the fixer fluid composition has a pH of less than about 7, for example a pH of less than about 6, for example a pH of less than about 5, for example a pH of less than about 4, for example a pH of less than about 3, for example a pH of less than about 2, for example a pH of about 1.5.

In some examples, the fixer fluid composition has a pH of greater than about 1.5, for example a pH of greater than about 2, for example a pH of greater than about 3, for example a pH of greater than about 4, for example a pH of greater than about 5, for example a pH of greater than about 6, for example a pH of about 7. In some examples, the fixer fluid composition has a pH in the range of from 6 to 7. Any number of commonly known buffers may be used to establish a desired pH level in the inkjet system. In one example, the fixer fluid composition comprises a Tris-based buffer. In one example, the pH of the fixer fluid composition is adjusted using aqueous potassium hydroxide.

The fixer fluid composition may also include one or more surfactants. The surfactant may be present to lower surface tension. As an example, the ink may include non-ionic, cationic, and/or anionic surfactants, which may be present in an amount ranging from about 0.01 to 5 wt. % based on the total concentration of the fixer fluid composition. In some examples, the surfactant may be a non-ionic surfactant, such as a silicone-free alkoxylated alcohol surfactant such as, for example, Surfynol® SE-F or Surfynol CT-211 (Evonik Industries), present in an amount of about 0.01 to 1 wt. % of the total fixer fluid composition, for example, present in an amount of about 0.1 wt. %. Other suitable surfactants include non-ionic fluorosurfactants, including those available from DuPont™ such as Capstone® FS-35, FS-34, FS-65 and the Zonyl® range of fluorosurfactants such as FSO-100.

The fixer fluid composition may also include any number of anti-microbial agents, sequestering agents, and viscosity modifiers. Additionally, various anti-microbial agents can be used to inhibit growth of undesirable microorganisms. Suitable antimicrobial agents may include biocides and fungicides, which are routinely used in ink formulations and fixer formulations. Several examples of suitable antimicrobial agents may include, but are not limited to, benzoate salts, sorbate salts, commercial products such as Acticide® B20 (THOR), Acticide® M20 (THOR), NUOSEPT™ (ISP), UCARCIDE™ (Dow Chemical™), VANCIDE® (RT Vanderbilt™ Co.), and PROXEL™ (Avecia) and other know biocides. Examples of suitable fungicides may include Kordek™ LX (Rohm and Haas™) and Bioban™ CS-1246 (Dow Chemical™). Typically, such anti-microbial agents may be present in a range of about 0.05 to 2 wt. %. In an example, the fixer fluid composition may include a total amount of antimicrobial agents that ranges from about 0.1 wt. % to about 0.25 wt. %.

Sequestering agents, such as EDTA (ethylene diamine tetra acetic acid), may be included to eliminate the deleterious effects of heavy metal impurities. From 0 to 2 wt. %, for example, can be used.

As mentioned above, the balance of the present fixer fluid composition includes water.

There is also provided herein a method of preparing a fixer fluid composition comprising mixing a polyvalent metal salt, a cationic polymer, and a liquid vehicle, wherein the ratio of polyvalent metal salt to cationic polymer is in a range of 1:1 to 3.5:1. In one example, the polyvalent metal salt, cationic polymer and liquid vehicle are mixed at a temperature sufficient to ensure formation of a homogeneous composition.

### Ink Composition

The method of printing described herein may comprise applying an ink composition onto a fixer fluid composition on a substrate. The method may be a method of inkjet printing and may comprise jetting an ink composition. In some examples, the method may comprise printing an ink composition comprising a polymer. In some examples, the method of inkjet printing may comprise printing an ink composition other than a latex ink composition, for example a water-based ink comprising a polyurethane dispersion or other water-soluble polymers.

In some examples, the ink composition is a liquid thermal inkjet ink composition comprising a colourant dispersed in an ink vehicle. In some examples, the ink vehicle can be an aqueous vehicle. The term aqueous vehicle can refer to water or a mixture of water and at least one water-soluble or partially water-soluble organic solvent.

### Polymer

In some examples, the method may comprise printing an ink composition comprising a polymer in the form of a polyurethane dispersion. In some examples, the method may comprise printing an ink composition comprising a water-soluble polymer. In some examples, the method may comprise printing a latex-containing ink composition comprising a latex polymer.

### Latex Polymer

Latex polymers can be prepared using any of a number of methods known in the art, including but not limited to emulsion polymerisation techniques where co-monomers are dispersed and polymerised in a discontinuous phase of an emulsion. The latexes can also be dispersions of polymer prepared by other techniques known to those in the art.

The monomers used in the latexes can be vinyl monomers. In some examples, the monomers from which the latex polymer is formed are selected from vinyl monomers, acrylate monomers, methacrylate monomers, styrene monomers, ethylene monomers, vinyl chloride, vinylidene chloride, maleate esters, fumarate esters, itaconate esters and combinations thereof. In some examples, monomers from which the latex polymer is formed may comprise ethyl acrylate; ethyl methacrylate; benzyl acrylate; benzyl methacrylate; propyl acrylate; propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxypropylmethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; iso-butyl acrylate; iso-butyl methacrylate; 2-ethylhexyl acrylate; 2-ethylhexyl methacrylate; iso-octyl acrylate; iso-octyl methacrylate; and combinations thereof.

In some examples, the latex polymer is formed from monomers selected from styrenes, C₁ to C₈ alkyl methacrylates, C₁ to C₈ alkyl acrylates, ethylene glycol methacrylates and dimethacrylates, methacrylic acids, acrylic acids, and combinations thereof. Examples of latex polymers that can be used include those prepared using a monomer emulsion of methyl methacrylate, butyl acrylate, cyclohexyl methacrylate and methacrylic acid, which are copolymerised to form the latex.

In some examples the monomers from which the latex polymer is formed include acid monomers, such as (meth)acrylic acid monomers. Acidic monomers that can be polymerised in forming latexes include, without limitation, acrylic acid, methacrylic acid, ethacrylic acid, dimethylacrylic acid, maleic anhydride, maleic acid, vinylsulphonate, cyanoacrylic acid, vinylacetic acid, allylacetic acid, ethylidineacetic acid, propylidineacetic acid, crotonic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, vinylbenzoic acid, N-vinylsuccinamidic acid, mesaconic acid, methacroylalanine, acryloylhydroxyglycine, sulphoethyl methacrylic acid, sulphopropyl acrylic acid, styrene sulphonic acid, sulphoethylacrylic acid, 2-methacryloyloxymethane-1-sulphonic acid, 3-methacryloyloxypropane-1-sulphonic acid, 3-(vinyloxy)propane-1-sulphonic acid, ethylenesulphonic acid, vinyl phosphoric acid, vinyl benzoic acid, 2-acrylamido-2-methyl-1-propanesulphonic acid, combinations thereof, derivatives thereof, and mixtures thereof.

In some examples, the latex polymer comprises a (meth)acrylate polymer or copolymer. In some examples, the latex polymer comprises a (meth)acrylate copolymer. For example, the latex polymer may comprise a copolymer of a (meth)acrylate monomer and another vinyl monomer, for example another vinyl monomer selected from styrenes, C₁ to C₈ alkyl methacrylates, C₁ to C₈ alkyl acrylates, ethylene glycol methacrylates and dimethacrylates, methacrylic acids, acrylic acids, and combinations thereof.

In some examples, the latex polymer comprises a (meth)acrylate polymer being a polymer comprising (meth)acrylate monomers or a (meth)acrylate copolymer being a copolymer comprising (meth)acrylate monomers. In some examples, the latex polymer comprises a (meth)acrylate copolymer comprising (meth)acrylate monomers. In some examples, the (meth)acrylate copolymer comprises (meth)acrylate monomers and vinyl monomers selected from styrenes, C₁ to C₈ alkyl methacrylates, C₁ to C₈ alkyl acrylates, ethylene glycol methacrylates and dimethacrylates, methacrylic acids, acrylic acids, and combinations thereof.

In some examples, the (meth)acrylate monomers are selected from aliphatic (meth)acrylate monomers, aromatic (meth)acrylate monomers and combinations thereof.

In some examples, aliphatic (meth)acrylate monomers comprise linear aliphatic (meth)acrylate monomers and/or cycloaliphatic (meth)acrylate monomers.

In some examples, linear (meth)acrylate monomers comprise alkyl (meth)acrylate monomers (for example C₁ to C₈ alkyl (meth)acrylate monomers). In some examples, the linear (meth)acrylate monomers comprise alkyl methacrylate monomers (e.g. C₁ to C₈ alkyl methacrylate monomers). In some examples, the linear (meth)acrylate monomers comprise alkyl methacrylate monomers (e.g. C₁ to C₈ alkyl (meth)acrylate monomers) and alkyl acrylate monomers (C₁ to C₈ alkyl acrylate monomers).

In some examples, the latex polymer comprises a copolymer comprising alkyl (meth)acrylate (e.g. C₁ to C₈ alkyl (meth)acrylate monomers) and styrene monomers. In some examples, the latex polymer comprises a copolymer comprising alkyl (meth)acrylate (e.g. C₁ to C₈ alkyl (meth)acrylate monomers), cyclohexyl methacrylate monomers and (meth)acrylic acid monomers.

In some examples, the latex inkjet ink composition comprises up to about 35 wt. % latex polymer by total weight of the inkjet ink composition. In some examples, the latex inkjet ink composition comprises up to about 30 wt. % latex polymer by total weight of the inkjet ink composition. In some examples, the latex inkjet ink composition comprises up to about 25 wt. % latex polymer by total weight of the inkjet ink composition.

In some examples, the inkjet ink composition comprises at least about 1 wt. % latex polymer by total weight of the inkjet ink composition. In some examples, the latex inkjet ink composition comprises at least about 2 wt. % latex polymer by total weight of the inkjet ink composition. In some examples, the latex inkjet ink composition comprises at least about 5 wt. % latex polymer by total weight of the inkjet ink composition. In some examples, the latex inkjet ink composition comprises at least about 10 wt. % latex polymer by total weight of the inkjet ink composition.

In some examples, the latex inkjet ink composition comprises from about 1 wt. % to about 35 wt. % latex polymer by total weight of the inkjet ink composition. In some examples, the latex inkjet ink composition comprises from about 2 wt. % to about 30 wt. % latex polymer by total weight of the inkjet ink composition. In some examples, the latex inkjet ink composition comprises from about 5 wt. % to about 25 wt. % latex polymer by total weight of the inkjet ink composition.

### Pigment

In some examples, the inkjet ink composition comprises a pigment. For example, the inkjet ink composition may comprise a latex polymer, a pigment; and an ink vehicle.

The term “pigment” can include particular dispersible colourants that can be suspended or dispersed in a liquid vehicle in accordance with embodiments of the present invention. Irrespective of other pigments that may be present, at least one pigment type that must be present is a polymer-attached pigment. “Polymer-attached pigments” include pigments having a polymer covalently attached to the surface of the pigment, a polymer adsorbed or grafted onto the surface of the pigment, or a pigment at least partially encapsulated by a polymer. The pigment itself can be a self-dispersed pigment or a non self-dispersed pigment. Self-dispersed pigments include those that have been chemically surface modified with a charge or a polymeric grouping. This chemical modification aids the pigment in becoming and/or substantially remaining dispersed in a liquid vehicle. When a polymeric grouping provides the surface modification, then it is considered to be a polymer-attached pigment without further modification, though further modification is not precluded. The pigment used to form the polymer-attached pigment can also be a non self-dispersed pigment that utilises a separate and unattached dispersing agent (which can be a polymer, an oligomer, or a surfactant, for example) in the liquid vehicle or physically coated on the surface of the pigment.

The pigment may include black pigments, white pigments, cyan pigments, magenta pigments, yellow pigments, or the like. Suitable inorganic pigments include, for example, carbon black. However, other inorganic pigments may be suitable such as titanium oxide, cobalt blue (CoO—Al₂O₃), chrome yellow (PbCrO₄), and iron oxide. Suitable organic pigments include, for example, azo pigments including diazo pigments and monoazo pigments, polycyclic pigments (e.g. phthalocyanine pigments such a phthalocyanine clue and phthalocyanine greens, perylene pigments, perynone pigments, anthraquinone pigments, quinacridone pigments, dioxazine pigments, thioindigo pigments, isoindolinone pigments, pyranthrone pigments, and quinophthalone pigments), insoluble dye chelates (e.g., basic dye type chelates and acidic dye type chelate), nitropigments, nitroso pigments, and the like. Representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigmen Red 202, Pigment Red 206, Pigment Red 207, Pigment Red 209, Pigment Violet 19 and Pigment Violet 42. Representative examples of anthraquinones include Pigment Red 43, Pigment Red 194 (Perinone Red), Pigment Red 216 (Brominated Pyranthrone Red) and Pigment Red 226 (Pyranthrone Red). Representative examples of perylenes include Pigment Red 123 (Vermillion), Pigment Red 149 (Scarlet), Pigment Red 179 (Maroon), Pigment Red 190 (Red), Pigment Violet 19, Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128 and Pigment Yellow 138, Pigment Yellow 155, Pigment Yellow 83, and Pigment Yellow 213. Such pigments are commercially available in either powder or press cake form from a number of sources including, BASF™ Corporation, Engelhard™ Corporation and Sun Chemical™ Corporation.

Examples of black pigments that can be used include carbon pigments. The carbon pigment can be almost any commercially available carbon pigment that provides acceptable optical density and print characteristics. Carbon pigments suitable for use in the present system and method include, without limitation, carbon black, graphite, vitreous carbon, charcoal, and combinations thereof. Such carbon pigments can be manufactured by a variety of known methods such as a channel method, a contact method, a furnace method, an acetylene method, or a thermal method, and are commercially available from such vendors as Cabot™ Corporation, Columbian Chemicals Company, Degussa AG™, and E.I. DuPont™ de Nemours and Company. Suitable carbon black pigments include, without limitation, Cabot pigments such as MONARCH™ 1400, MONARCH™ 1300, MONARCH™ 1100, MONARCH™ 1000, MONARCH™ 900, MONARCH™ 880, MONARCH™ 800, MONARCH™ 700, CAB-O-JET™ 200, CAB-O-JET™ 300, REGAL, BLACK PEARLS™, ELFTEX™, MOGUL™, and VULCAN™ pigments; Columbian pigments such as RAVEN™ 7000, RAVEN™ 5750, RAVEN™ 5250, RAVEN™ 5000, and RAVEN™ 3500; Degussa pigments such as Color Black FW 200, RAVEN™ FW 2, RAVEN™ FW 2V, RAVEN™ FW 1, RAVEN™ FW 18, RAVEN™ S160, RAVEN™ FW S170, Special Black™ 6, Special Black™ 5, Special Black™ 4A, Special Black™ 4, PRINTEX™ U, PRINTEX™ 140U, PRINTEX™ V and PRINTEX™ 140V; and TIPURE™ R-101 available from DuPont™. The above list of pigments includes unmodified pigment particulates, small molecule attached pigment particulates, and polymer-dispersed pigment particulates.

Similarly, a wide variety of coloured pigments can be used with the inkjet ink composition, therefore the following listing is not intended to be limiting. For example, coloured pigments can be blue, brown, cyan, green, white, violet, magenta, red, orange, yellow, as well as mixtures thereof. The following colour dispersions are available from Cabot™ Corp.: CABO-JET™ 250C, CABO-JET™ 260M, and CABO-JET™ 270Y. The following colour pigments are available from BASF™ Corp.: PALIOGEN™ Orange, PALIOGEN™ Orange 3040, PALIOGEN™ Blue L 6470, PALIOGEN™ Violet 5100, PALIOGEN™ Violet 5890, PALIOGEN™ Yellow 1520, PALIOGEN™ Yellow 1560, PALIOGEN™ Red 3871K, PALIOGEN™ Red 3340, HELIOGEN™ Blue 6901F, HELIOGEN™ Blue NBD 7010, HELIOGEN™ Blue K 7090, HELIOGEN™ Blue L 7101F, HELIOGEN™ Blue L6900, L7020, HELIOGEN™ Blue D6840, HELIOGEN™ Blue

D7080, HELIOGEN™ Green L8730, HELIOGEN™ Green K 8683, and HELIOGEN™ Green L 9140. The following pigments are available from Ciba-Geigy Corp.: CHROMOPHTAL™ Yellow 3G, CHROMOPHTAL™ Yellow GR, CHROMOPHTAL™ Yellow 8G, IGRAZIN™ Yellow 5GT, IGRALITE™ Rubine 4BL, IGRALITE™ Blue BCA, MONASTRAL™ Magenta, MONASTRAL™ Scarlet, MONASTRAL™ Violet R, MONASTRAL™ Red B, and MONASTRAL™ Violet Maroon B. The following pigments are available from Heubach Group™: DALAMAR™ Yellow YT-858-D and HEUCOPHTHAL™ Blue G XBT-583D. The following pigments are available from Hoechst Specialty Chemicals™: Permanent Yellow GR, Permanent Yellow G, Permanent Yellow DHG, Permanent Yellow NCG-71, Permanent Yellow GG, Hansa Yellow RA, Hansa Brilliant Yellow 5GX-O2, Hansa Yellow-X, NOVOPERM™ Yellow HR, NOVOPERM™ Yellow FGL, Hansa Brilliant Yellow 10GX, Permanent Yellow G3R-01, HOSTAPERM™ Yellow H4G, HOSTAPERM™ Yellow H3G, HOSTAPERM™ Orange GR, HOSTAPERM™ Scarlet GO, HOSTAPERM™ Pink E, Permanent Rubine F6B, and the HOSTAFINE™ series. The following pigments are available from Mobay Corp.: QUINDO™ Magenta, INDOFAST™ Brilliant Scarlet, QUINDO™ Red R6700, QUINDO™ Red R6713, and INDOFAST™ Violet. The following pigments are available from Sun Chemical Corp.: L74-1357 Yellow, L75-1331 Yellow, and L75-2577 Yellow. Other examples of pigments can include Normandy Magenta RD-2400, Permanent Violet VT2645, Argyle Green XP-111-S, Brilliant Green Toner GR 0991, Sudan Blue OS, PV Fast Blue B2GO1, Sudan III, Sudan II, Sudan IV, Sudan Orange G, Sudan Orange 220, Ortho Orange OR 2673, Lithol Fast Yellow 0991 K, Paliotol Yellow 1840, Lumogen Yellow D0790, Suco-Gelb L1250, Suco-Yellow D1355, Fanal Pink D4830, Cinquasia Magenta, Lithol Scarlet D3700, Toluidine Red, Scarlet for Thermoplast NSD PS PA, E. D. Toluidine Red, Lithol Rubine Toner, Lithol Scarlet 4440, Bon Red C, Royal Brilliant Red RD-8192, Oracet Pink RF, Lithol Fast Scarlet L4300, and white TIPURE R-101. These pigments are available from commercial sources such as Hoechst Celanese Corporation™, Paul Uhlich, BASF, American Hoechst™, Ciba-Geigy™, Aldrich™, DuPont™, Ugine Kuhlman of Canada™, Dominion Color Company™, Magruder™, and Matheson™. Examples of other suitable coloured pigments are described in the Colour Index, 3^{rd} edition (The Society of Dyers and Colourists, 1982).

In some examples, the inkjet ink composition comprises an ink vehicle. In some examples, the ink vehicle comprises water, i.e. is an aqueous ink vehicle.

In some examples, the ink vehicle may include a variety of different agents, including without limitation, surfactants, co-solvents, buffers, biocides, viscosity modifiers, sequestering agents, stabilising agents, and water.

In one example, the ink vehicle includes water as the base solvent and so is termed an aqueous ink vehicle.

### Co-Solvent

In one example, the ink vehicle also includes one or more co-solvents. Classes of co-solvents that can be used can include organic co-solvents including aliphatic alcohols, aromatic alcohols, diols, glycol ethers, polyglycol ethers, 2-pyrrolidinones, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologues (C₆-C₁₂) of polyethylene glycol ethers, N-alkyl caprolactams, unsubstituted caprolactams, both substituted and unsubstituted formamides, both substituted and unsubstituted acetamides, and the like.

In one example, the ink vehicle includes one or more aliphatic alcohols as co-solvents in an amount of at least about 4 wt. % of the total weight of the ink composition, for example at least about 5 wt. %, for example at least about 6 wt. %, for example at least about 7 wt. %, for example at least about 8 wt. %, for example at least about 9 wt. %, for example at least about 10 wt. %, for example at least about 12 wt. %, for example at least about 14 wt. %, for example at least about 16 wt. %, for example at least about 18 wt. %, for example at least about 20 wt. %, for example at least about 25 wt. %, for example at least about 30 wt. %, for example at least about 35 wt. %, for example at least about 40 wt. %.

In one example, the ink vehicle includes one or more aliphatic alcohols as co-solvents in an amount of less than about 40 wt. % of the total weight of the ink composition, for example less than about 35 wt. %, for example less than about 30 wt. %, for example less than about 25 wt. %, for example less than about 20 wt. %, for example less than about 18 wt. %, for example less than about 16 wt. %, for example less than about 14 wt. %, for example less than about 12 wt. %, for example less than about 10 wt. %, for example less than about 9 wt. %, for example less than about 8 wt. %, for example less than about 7 wt. %, for example less than about 6 wt. %, for example less than about 5 wt. %, for example about 4 wt. %.

In one example, the ink vehicle includes butanediol, for example 1,2-butanediol as co-solvent in an amount of at least 4 wt. % of the total weight of the ink composition. In one example, the ink vehicle comprises butanediol, for example 1,2-butanediol, in the amounts stated in the preceding paragraphs.

In one example, the ink vehicle includes one or more glycol ethers as co-solvents. In one example, the ink vehicle includes one or more glycol ethers as co-solvents in an amount of at least about 0.05 wt. % of the total of the ink composition, for example at least about 0.1 wt. %, for example at least about 0.5 wt. %, for example at least about 1 wt. %, for example at least about 1.5 wt. %, for example at least about 2 wt. %, for example at least about 2.5 wt. %, for example at least about 3 wt. %, for example at least about 3.5 wt. %, for example at least about 4 wt. %, for example at least about 4.5 wt. %, for example at least about 5 wt. %.

In one example the ink vehicle includes one or more glycol ethers as co-solvents in an amount of less than about 5 wt. % of the total weight of the ink composition, for example less than about 4.5 wt. %, for example less than about 4 wt. %, for example less than about 3.5 wt. %, for example less than about 3 wt. %, for example less than about 2.5 wt. %, for example less than about 2 wt. %, for example less than about 1.5 wt. %, for example less than about 1 wt. %, for example less than about 0.5 wt. %, for example less than about 0.1 wt. %, for example less than about 0.05 wt. %. Suitable glycol ethers include ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monoethyl ether, diethylene glycol mono-n-butyl ether, tripropylene glycol methyl ether, available from Dow or Sigma-Aldrich. In one example, the ink vehicle comprises tripropylene glycol methyl ether in the amounts stated in the preceding paragraphs.

### Additives

In one example, the inkjet ink composition may include a wax. Wax emulsions are commercially available from a number of vendors, for example Keim-Additec™, Lubrizol™, Michelman™, and BYK Chemie™. Wax emulsions that are useful include but are not limited to: Lubrizol™: Liquilube™ 411, Liquilube™ 405, Liquilube™ 488, Liquilube™ 443, Liquilube™ 454; Michelman: ME80825, ME48040, ME98040M1, ME61335, ME90842, ME91240, ML160; Keim-Additec: Ultralube® E-521/20, Ultralube® E-7093, Ultralube® 7095/1, Ultralube® E-8046, Ultralube® E-502V, Ultralube® E-842N; Byk: Aquacer® 2650, Aquacer® 507, Aquacer® 533, Aquacer® 515, Aquacer® 537, Aquaslip™ 671, Aquaslip™ 942.

In one example, the wax can have a melting point ranging from 60° C. to 110° C. Generally, the wax can have a particle size ranging from 50 nm to 600 nm. In one example, the wax can have a particle size ranging from 200 nm to 300 nm. Generally, the wax can be present in the ink at a concentration ranging from 0.25 wt. % to 5 wt. %. In one example, the wax can be present ranging from 0.5 wt. % to 1.5 wt. %. Additionally, the wax emulsions can be compatible with high acid acrylic dispersants and hydrocolloids. By compatible, the present waxes can be used without causing aggregation or precipitation of the dispersants/hydrocolloids particularly over extended periods of time (weeks/months at ambient temperature or days/weeks at elevated temperature such as 40° C. to 65° C.). Incompatibility can manifest itself variously by increases in wax particle size, phase separation of wax, or creaming at a faster rate than in the absence of destabilising materials.

In one example, the inkjet ink composition may further comprise one or more surfactants. In one example, one or more non-ionic, cationic, and/or anionic surfactants can be present in the inkjet ink composition described, ranging from 0.01 wt. % to 10 wt. %. Non-limiting examples of such surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, substituted amine oxides, polyethylene oxide alkyl sulphonates, polyethylene oxide alkyl sulphates, polyethylene oxide alkyl phosphates, and the like, as well as fluorocarbon and silicone surfactants. In one example, the present inkjet inks can include alkyl ethoxylate surfactants. Such surfactant can include, but are not limited to, TERGITOL® 15-S-7, TERGITOL® 15-S-9, TERGITOL® TMN-6 90 percent, and NEODOL® 91-6. In one example, the one or more surfactants can have an HLB value ranging from about 12 to about 13.5. As used herein, “HLB” refers to hydrophile-lipophile-balance which is a measure of the balance or proportion of hydrophilic to lipophilic portions of a molecule. In another example, the one or more surfactants can each be present in the inkjet ink at a concentration ranging from about 0.01 wt. % to about 0.5 wt. %.

Various other additives may be employed to enhance the properties of the inkjet ink composition for specific application. Examples of these additives are those added to inhibit the growth of harmful microorganisms. These additives may be biocides, fungicides, and other microbial agents, which are routinely used in ink formulations. Examples of suitable microbial agents include but are not limited to, NUOSEPT® (Nudex™, Inc.), UCARCIDE™ (Union carbide™ Corp.), VANCIDE® (R.T. Vanderbilt™ Co.), PROXEL® (ICI™ America), and combinations thereof.

### Over-Print Varnish Composition

The method of printing described herein comprises over-printing a varnish composition. In some examples, the varnish composition comprises a polymer, water, and a co-solvent. In some examples, the varnish composition comprises a polyurethane dispersion. In some examples, the varnish composition comprises a latex polymer. In some examples, the varnish composition comprises an aqueous polyurethane dispersion. In some examples, the varnish composition comprises a latex polymer or a polyurethane polymer, a polymeric salt, water, and a co-solvent. In some examples, the varnish composition comprises a latex polymer, a polymeric salt, water, and a co-solvent. In some examples, the varnish composition is a piezo-jettable varnish composition.

The varnish compositions described herein are aqueous compositions. Such compositions are environmentally preferable compared to solvent-based or UV curable compositions.

In some examples, the varnish composition has a viscosity in the range of about 5-20 cP, where the viscosity is measured at the jetting temperature (i.e. the temperature at which the composition is to be jetted). In some examples, the jetting temperature is a temperature in the range of about 10° C. to about 50° C., for example about 20-40° C., or about 25 ° C.

In some examples, the varnish composition has a viscosity of at least about 5 cP at 25° C. In some examples, the varnish composition has a viscosity of up to about 30 cP at 25° C., for example up to about 25 cP at 25° C., or up to about 20 cP at 25° C. In some examples, the varnish composition has a viscosity in the range of about 5-20 cP at 25° C.

The viscosity of the varnish composition may be determined according to IS03219, DIN.

In some examples, the viscosity of the varnish composition is adjusted by adjusting the amount of water contained in the composition.

In some examples, the varnish composition has a surface tension in the range of about 20-40 dynes/cm, where the surface tension is measured at the jetting temperature (i.e. the temperature at which the composition is to be jetted). In some examples, the jetting temperature is a temperature in the range of about 10° C. to about 50° C., for example about 20-40° C., or about 25° C.

In some examples, the varnish composition has a surface tension of at least about 15 dynes/cm at 25° C., for example at least about 20 dynes/cm at 25° C. In some examples, the varnish composition has a surface tension of up to about 50 dynes/cm at 25° C., for example up to about 45 dynes/cm at 25° C., or up to about 40 dynes/cm at 25° C. In some examples, the varnish composition has a surface tension in the range of about 20 to about 40 dynes/cm at 25° C.

The surface tension of the varnish composition may be determined according to ASTM D1331-89.

In some examples, the varnish composition contains water in an amount of from about 40 wt % to about 90 wt % by total weight of the composition, for example from about 50 wt % to about 85 wt % by total weight of the composition.

In some examples, the jettable varnish composition comprises up to about 50 wt % solids by total weight of the composition, for example, up to about 40 wt % solids, or up to about 30 wt % solids by total weight of the composition. In some examples, the jettable varnish composition comprises at least 5 wt % solids by total weight of the varnish composition, for example at least about 10 wt % solids, or at least about 15 wt % solids by total weight of the varnish composition. In some examples, the varnish composition comprises from about 10 wt % to about 30 wt % solids by total weight of the composition.

As used herein, the term “solids” of the varnish compositions is used to refer to the components of the varnish composition that remain after a varnish image formed by printing a varnish composition is dried, for example following evaporation of water and the co-solvent from the varnish composition. For example, the term “solids” of the varnish composition includes the polymeric salt as well as the polyurethane or latex polymer, even though the polymeric salt is soluble in the aqueous varnish composition. The “solids” of the varnish composition may also include waxes and/or surfactants that may be included in the varnish composition.

The varnish composition may be a transparent (e.g. transparent and colourless) varnish composition, for example having no or substantially no colorant (e.g. pigment) and thus may be a pigment-free, or substantially pigment-free composition. The varnish composition may comprise less than 2 wt % solids of colorant, in some examples less than 1 wt % solids of colorant, in some examples less than 0.5 wt % solids of colorant, in some examples less than 0.1 wt % solids of colorant. A “colorant” may be a material that imparts a color to the composition. As used herein, “colorant” includes pigments and dyes, such as those that impart colors such as black, magenta, cyan and yellow to an ink. As used herein, “pigment” generally includes pigment colorants, magnetic particles, aluminas, silicas, and/or other ceramics or organo-metallics. In some examples, the varnish composition when printed as an overcoat varnish layer over a printed image does not substantially affect the colour of an underprinted image when viewed with the naked eye.

The present inventors have found that the varnish compositions described herein may form films around ambient temperature (e.g. around 25° C.) and are therefore useful to protect underprinted images without requiring additional heating to provide a protective film (e.g. a continuous (i.e. uncracked) film) from the varnish composition. In some examples, the varnish composition has a minimum film formation temperature (MFFT) of up to about 40° C., in some examples up to about 30° C. or up to about 25° C. In some examples, the varnish composition has a MFFT in the range of about 10° C. to about 40° C., for example about 10° C. to about 30° C., about 15° C. to about 30° C., or about 20° C. to about 30° C. In some examples, the varnish composition has a MFFT of about 25° C. The MFFT of a varnish composition may be determined using a MFFT 90 Minimum Film Forming Temperature Instrument (available from Rhopoint™ Instruments). The MFFT of a varnish composition may be determined according to ASTM D2354.

### Polyurethane Dispersion

In some examples, the varnish composition comprises a polyurethane dispersion. As used herein, the term “dispersion” refers to a two-phase system where one phase consists of finely divided particles of polyurethane binder distributed throughout a second phase of a bulk substance, i.e. liquid vehicle. In some examples, polyurethane dispersion comprises polyurethane polymer particles dispersed in water.

In some examples, the polyurethane dispersion is present in the varnish composition in an amount of at least 10 wt % based on the total solids of the composition. In some examples, the polyurethane dispersion is present in the varnish composition in an amount of at least 20 wt % based on the total solids of the composition. In some examples, the polyurethane dispersion is present in the varnish composition in an amount of at least 30 wt % based on the total solids of the composition. In some examples, the polyurethane dispersion is present in the varnish composition in an amount of at least 40 wt % based on the total solids of the composition. In some examples, the polyurethane dispersion is present in the varnish composition in an amount of at least 50 wt % based on the total solids of the composition. In some examples, the polyurethane dispersion is present in the varnish composition in an amount of at least 60 wt % based on the total solids of the composition.

In some examples, the polyurethane dispersion is present in the varnish composition in an amount of less than 60 wt % based on the total solids of the composition. In some examples, the polyurethane dispersion is present in the varnish composition in an amount of less than 50 wt % based on the total solids of the composition. In some examples, the polyurethane dispersion is present in the varnish composition in an amount of less than 40 wt % based on the total solids of the composition. In some examples, the polyurethane dispersion is present in the varnish composition in an amount of less than 30 wt % based on the total solids of the composition. In some examples, the polyurethane dispersion is present in the varnish composition in an amount of less than 20 wt % based on the total solids of the composition In some examples, the polyurethane dispersion is present in the varnish composition in an amount of less than 10 wt % based on the total solids of the composition.

In some examples, the polyurethane dispersion is present in the varnish composition in an amount of from 10 wt % to 60 wt % based on the total solids of the composition, for example from 20 wt % to 50 wt %, for example from 25 wt % to 40 wt %, for example from 30 wt % to 35 wt % of the total solids of the composition.

In some examples, the polyurethane dispersion is present in the varnish formulation in an amount ranging from about 1 wt % to about 30 wt % based upon the total wt % of the varnish formulation. In some other examples, the polyurethane dispersion is present in the varnish formulation an amount ranging from about 2 wt % to about 25 wt % based upon the total wt % of the varnish formulation. In yet some other examples, the polyurethane dispersion is present in the varnish formulation an amount ranging from about 3 wt % to about 18 wt % based upon the total wt % of the varnish formulation. The weight percentages given for the polyurethane dispersion do not account for any other components (e.g., water) that may be present when the polyurethane is part of the dispersion.

In some examples, the polyurethane polymer of the dispersion has a weight average molecular weight of greater than about 100,000 Mw. In some examples, the polyurethane polymer of the dispersion has a weight average molecular weight of up to about 2,000,000 Mw, for example up to about 1,000,000 Mw, up to about 500,000 Mw, up to about 300,000 Mw, or up to about 250,000 Mw. In some examples, the polyurethane polymer of the dispersion has a weight average molecular weight in the range of about 100,000 Mw to about 300,000 Mw. In some examples, the polyurethane polymer of the dispersion has a weight average molecular weight in the range of about 50,000 Mw to about 250,000 Mw.

In some examples, polymeric particulates of the polyurethane polymer of the dispersion have an average particle size of about 500 nm or less, for example about 200 nm or less, or about 100 nm or less. In some examples, polymeric particulates of the polyurethane polymer of the dispersion have an average particle size of about 20 nm or greater. In some examples, polymeric particulates of the polyurethane polymer of the dispersion have an average particle size in the range of about 20 nm to about 200 nm, for example about 20 nm to about 100 nm. The average particle size (e.g. volume or intensity weighted average particle size) may be determined by dynamic light scattering.

In some examples, the polyurethane polymer of the polyurethane dispersion comprises an anionic polyurethane, a cationic polyurethane, or a non-ionic polyurethane. In their simplest form, polyurethane polymers are formed by reacting an isocyanate and a polyol. Ionic polyurethane polymers may be formed by including a modifier in the polymer backbone, or pendant from the main backbone. One example of a modifier is is dimethylol propionic acid (DMPA), which contains two hydroxy group and a carboxylic acid group. The OH groups react with the isocyanate groups to produce an NCO terminated prepolymer but with a pendant COOH group, thus introducing an anionic character to the polyurethane. Another example of a modifier is 1,1′-{[3-(dimethylamino)propyl]imino}-bis-2-ethanol, which contains a pendant tertiary amino group, thus introducing a cationic character to the polyurethane.

Examples of suitable polyurethanes include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, a vinyl-urethane hybrid polymer, an acrylic-urethane hybrid polymer, a co-polymer thereof, and a combination thereof. In one example, the polyurethane dispersion comprises an aliphatic polyurethane, a cycloaliphatic polyurethane or an aromatic polyurethane. The polyurethanes can include polyurethane, polyurea, polyurethane-graph polyol, or a combination thereof. In a further example, the binder can include a polyurethane graph polyol such as PUG-49, PUG-84, PUG-400 or Pluracol® (available from BASF, New Jersey). In yet another example, the polyurethanes can further include an acrylic functional group. For example, the binder can include methyl methacrylate, 2-ethylhexyl acrylate, 2-(2-ethoxyethoxy)ethyl acrylate, or a combination thereof.

In some examples, the polyurethane comprises a polyisocyanate component (A) and a polyol (B). In some examples, the polyurethane contains a polyisocyanate component (A) and a first polyol (B) and a second polyol (C). The polyurethane can also be a polyurethane that comprises (A) a polyisocyanate; (B) a first polyol having a chain with two hydroxyl functional groups at one end of the chain and no hydroxyl groups at an opposed end of the chain; (C) a second polyol having a chain with two hydroxyl functional groups at both ends of the chain. In some examples, one or both of first polyol (B) and second polyol (C) comprises an ionic moiety in a side chain such as a carboxylate or amine so as to produce an anionic or cationic polyurethane polymer.

In some other examples, the polyurethane may be formed from the following components: (A) a polyisocyanate; (B) a polyol having a chain with two hydroxyl functional groups at one end of the chain and no hydroxyl functional groups at the opposed end of the chain; and (C) an alcohol, or a diol, with a number average molecular weight less than 500. In some examples, one or both of first polyol (B) and second polyol (C) comprises an ionic moiety in a side chain such as a carboxylate or amine so as to produce an anionic or cationic polyurethane polymer.

In some examples, when defining (A) the polyisocyanate, any suitable polyisocyanate may be used. Some suitable polyisocyanates have an average of about two or more isocyanate groups. In an example, the polyisocyanate includes an average of from about 2 to about 4 isocyanate groups per molecule and from about 5 to 20 carbon atoms (in addition to nitrogen, oxygen, and hydrogen). Component (A) may be an aliphatic, cycloaliphatic, araliphatic, or aromatic polyisocyanate, as well as products of their oligomerization, used alone or in mixtures of two or more. For example, a polyisocyanate having an average of two or more isocyanate groups may be used. Some examples of polyisocyanates include hexamethylene-1,6-diisocyanate (HDI), 2,2,4-trimethyl-hexamethylene-diisocyanate (TMDI), 1,12-dodecane diisocyanate, 2,4,4-trimethyl-hexamethylene diisocyanate, 2-methyl-1,5-pentamethylene diisocyanate, isophorone diisocyanate (IPDI), dicyclohexylmethane-4,4-diisocyanate (H12MD1), and combinations thereof. The amount of the polyisocyanate in the polyurethane dispersion ranges from about 20 wt % to about 45 wt % of the total weight of the polyurethane dispersion. In an example, polyisocyanate makes up from about 25 wt % to about 35 wt % of the polyurethane.

The amount of component (B) (i.e., the first polyol) in the polyurethane can range from about 10 wt % to about 70 wt % of the total weight of the polyurethane. In an example, component (B) (i.e., the first polyol) can make up from about 30 wt % to about 60 wt % of the polyurethane binder. The first polyol (B) can include any homopolymer or copolymer of poly(ethylene glycol) having one or two hydroxyl functional groups at one or both ends of its chain. The first polyol (B) can include any product having a chain with two hydroxyl groups at one end of the chain and no hydroxyl groups at the opposed end of the chain. The first polyol has a number average molecular weight (Mn) ranging from about 500 g/mol to about 5000 g/mol. Additionally, the first polyol has a glass transition temperature (Tg) ranging from about −20° C. to about 100° C. In an example, the glass transition temperature can range from about 0° C. to about 80° C. The first polyol may be formed from the free radical polymerization of a monomer in the presence of a mercaptan that includes two hydroxyl functional groups or two carboxylic functional groups. Some examples of the monomer used to form component (B) include an alkylester of acrylic acid or an alkylester of methacrylic acid, such as methyl (meth)acrylate, ethyl (meth)acrylate, n-butyl (meth)acrylate, tetrahydrofuryl (meth)acrylate, t-butyl (meth)acrylate, 2-ethylhexyl (meth)acrylate, hexyl (meth)acrylate, cyclohexyl (meth)acrylate, phenyl (meth)acrylate, benzyl (meth)acrylate, 2-aziridinylethyl (meth)acrylate, aminomethyl acrylate, aminoethyl acrylate, aminopropyl (meth)acrylate, amino-n-butyl(meth)acrylate, N,N-dimethylaminoethyl(meth)acrylate, N,N-dimethylaminopropyl (meth)acrylate, N,N-diethylaminoethyl (meth)acrylate, and N,N-diethylaminopropyl (meth)acrylate. Some other examples of the monomer used to form component (B) include an acid group containing monomer, such as acrylic acid, methacrylic acid, carboxyethyl (meth)acrylate, 2-(meth)acryloyl propionic acid, crotonic acid, and itaconic acid. In another example, the monomer used to form component (B) may be an acrylamide, an acrylamide derivative, methacrylamide, or a methacrylamide derivative. Some examples of acrylamide and methacrylamide derivatives include hydroxyethylacrylamide, N,N-methylol(meth)acrylamide, N-butoxymethyl (meth)acrylamide, and N-isobutoxymethyl (meth)acrylamide. Some further examples of the monomer used to form component (B) may be styrene or a styrene derivative. Some examples of styrene derivatives include alpha-methyl styrene, p-aminostyrene, and 2-vinylpyridine. Additionally, the monomer used to form component (B) may be acrylonitrile, vinylidene chloride, a fluorine containing acrylate, a fluorine containing methacrylate, a siloxane containing acrylate, a siloxane containing methacrylate, vinyl acetate, or N-vinylpyrrolidone. Some specific examples include 2,2,2-trifluoroethyl acrylate, 1H,1H,3H-hexafluorobutyl acrylate, 1H,1H,3H-tetrafluoropropyl methacrylate, 1H, 1H,5H-octafluoropentyl methacrylate, 1H, 1H,5H-octafluoropentyl acrylate, poly(dimethylsiloxane), methacryloxypropyl terminated polydimethylsiloxane DMS-R11 (made by Gelest Chemicals), and (3-acryloxy-2-hydroxypropoxypropyl) terminated polydimethylsiloxane DMS-U21 (made by Gelest Chemicals). It is to be understood that any combination of monomers listed for component (B) may be used.

In some examples, the polyol (B), and/or the second polyol (i.e., component (C) can be present in the polyurethane-based dispersion in an amount of from about 8 wt % to about 25 wt % based on the total weight of the polyurethane-based binder dispersion. In an example, component (B) (i.e., the first polyol) makes up from about 10 wt % to about 20 wt % of the polyurethane binder. The polyol(s) can have a number average molecular weight (Mn) of about 500 g/mol to about 3000 g/mol and have one hydroxyl group attached at each end of the polyol. Examples of polyols include polyester polyols, polyether polyols, polycarbonate polyol, polyester-polycarbonate polyol, or mixtures thereof. In some examples, the polyol can be poly(propyleneglycol), poly(tetrahydrofuran), poly(carbonate) polyol, or mixtures thereof. Examples of polycarbonate polyol include polycarbonate polyols from Kuraray Co. Ltd. (e.g., C-590, C-1050, C-1090, C-2050, C-2090, and C-3090) and polycarbonate diols from UBE Industries, Ltd. (e.g., Eternacoll® Uh-50, Eternacoll® Uh-100, Eternacoll® Uh-200, Eternacoll® Ph-5-, Eternacoll® Ph-100, Eternacoll® Ph-200 And Eternacoll® Um90(1/3)).

In some examples, the polyurethane compound comprises a homopolymer or copolymer of poly(ethylene glycol). The homopolymer or copolymer of poly(ethylene glycol) can have two hydroxyl functional groups or two amino functional groups at one or both ends of its chain. The homopolymer or copolymer of poly(ethylene glycol) has a number average molecular weight (Mn) ranging from about 500 g/mol to about 5,000 g/mol. In another example, the homopolymer or copolymer of poly(ethylene glycol) has a number average molecular weight (Mn) ranging from about 500 g/mol to about 3,000 g/mol. The homopolymer or copolymer of poly(ethylene glycol) has a water solubility of greater than 30% v/v (volume of poly(ethylene glycol) to volume of water). The amount of the homopolymer or copolymer of poly(ethylene glycol) in the polyurethane ranges from 0 wt % to about 20 wt % based upon the total weight of the polyurethane. In an example, the homopolymer or copolymer of poly(ethylene glycol) can be present in the polyurethane in an amount of from about 5 wt % to about 10 wt % of the polyurethane.

Any homopolymer of poly(ethylene glycol) with two hydroxyl or amino groups at one or both ends of the polymer chain may alternatively be used, as long as the homopolymer has water solubility of >about 30% v/v and a suitable number average molecular weight. As an example, the homopolymer may be two hydroxyl terminated poly(ethylene glycol), where both hydroxyls are located at one end of the chain. One commercially available example is YMER® N120 (a linear difunctional polyethylene glycol monomethyl ether from Perstorp).

In some examples, the polyurethane comprises a low molecular weight compound which contains an ionic group(s) or a group that is capable of forming an ionic group. In some examples the compound is termed a modifier. The modifier is desirable so that the polyurethane can be dissolved or dispersed in water after ionization with a base. Examples of the modifier may be derived from hydroxy-carboxylic acids having the general formula (HO)xQ(COOH)y, where Q is a straight or branched hydrocarbon radical containing 1 to 12 carbon atoms, and x and y each independently range from 1 to 3. Examples of suitable hydroxy-carboxylic acids include dimethylolpropionic acid (DMPA), dimethylol butanoic acid (DMBA), citric acid, tartaric acid, glycolic acid, lactic acid, malic acid, dihydroxymaleic acid, dihydroxytartaric acid, or the like, or mixtures thereof. Hydroxyls or amines containing a sulfonate functional group can also be used as component (c). Examples include taurine and aminopropylaminoethylsulfonate. Hydroxyls or amines containing a phosphate functional group can also be used as the modifier. An example includes glycerol phosphate disodium dehydrate.

Suitable polyurethane dispersions are also those which are commercially available from NeoResins under the designation NeoRez® R-600, or NeoRez® FP-967-D, as well as those under the designations ESSENTIAL CC4520, ESSENTIAL CC4560, ESSENTIAL R4100, and ESSENTIAL R4188 from Essential Industries, Inc. Other suitable aliphatic polyurethane dispersions include NeoRez® R-610 (available from NeoResins), NeoRez® R-605 XP (available from DSM) and Kamthane S-1801 (available from Kamsons). Other suitable aliphatic polyurethane dispersions are commercially available from BASF under the designations Epotal® FLX 3621 (an amorphous polyurethane dispersion), Epotal® P 350 (an elastomeric polyether polyurethane dispersion), Emuldur® 381 A (an elastomeric polyester polyurethane dispersion), Luphen® D 207 (an elastomeric polyester- polyurethane dispersion), Luphen® D 259 (an elastomeric polyether-polyurethane dispersion), and Luphen® 585 (an elastomeric polyester-polyurethane dispersion); from Lubrizol under the designations Sancure® 2170 and 2175; from Baxenden Chemicals under the designations Witcobond® 781 and 373-04 and BAYHYDROL PR240 from Bayer Material Science.

### Latex Polymer

In some examples, the varnish composition comprises a latex polymer. In some examples, the varnish composition comprises a latex polymer, a polymeric salt, water, and a co-solvent. In some examples, the latex polymer and polymeric salt are present in the varnish composition in amounts such that the ratio of latex polymer to polymeric salt by weight is in the range of greater than about 1:1 to about 8:1. The latex polymer of the varnish composition may have a weight averaged molecular weight Mw of greater than about 50 000.

In some examples, the jettable varnish composition comprises at least about 1 wt. % latex polymer by total weight of the composition, for example at least about 2 wt. %, at least about 3 wt. %, at least about 5 wt. %, or at least about 8 wt. % of the total weight of the varnish composition.

In some examples, the jettable varnish composition comprises up to about 45 wt. % latex polymer by total weight of the composition, for example up to about 40 wt. %, up to about 35 wt. %, up to about 30 wt. %, up to about 25 wt. %, up to about 20 wt. %, up to about 15 wt. %, or up to about 10 wt. % of the total weight of the varnish composition.

In some examples, the jettable varnish composition comprises from about 1 wt. % latex polymer to about 40 wt. % latex polymer by total weight of the composition, for example about 5 wt. % to about 25 wt. % latex polymer by total weight of the composition.

In some examples, the latex polymer has a weight average molecular weight of greater than about 100,000 Mw. In some examples, the latex polymer has a weight average molecular weight of up to about 2,000,000 Mw, for example up to about 2,000,000 Mw, up to about 500,000 Mw, up to about 300,000 Mw, or up to about 250,000 Mw. In some examples, the latex polymer has a weight average molecular weight in the range of about 100,000 Mw to about 300,000 Mw. In some examples, the latex polymer has a weight average molecular weight in the range of about 50,000 Mw to about 250,000 Mw.

In some examples, polymeric particulates of the latex polymer have an average particle size of about 500 nm or less, for example about 200 nm or less, or about 100 nm or less. In some examples, polymeric particulates of the latex polymer have an average particle size of about 20 nm or greater. In some examples, polymeric particulates of the latex polymer have an average particle size in the range of about 20 nm to about 200 nm, for example about 20 nm to about 100 nm. The average particle size (e.g. volume or intensity weighted average particle size) may be determined by dynamic light scattering.

In some examples, the latex polymer has an acid number of less than about 150 mg KOH/g, for example less than about 100 mg KOH/g, less than about 80 mg KOH/g, less than about 70 mg KOH/g, or less than about 50 mg KOH/g.

The acid number of a polymer, as measured in mg KOH/g can be measured using standard procedures known in the art, for example using the procedure described in ASTM D1386.

In some examples, the latex polymer has a weight averaged molecular weight of greater than about 50,000 Mw (e.g. greater than about 100,000 Mw) and an acid number of less than about 150 mg KOH/g (e.g. less than about 100 mg KOH/g, less than about 80 mg KOH/g, less than about 70 mg KOH/g, or less than about 50 mg KOH/g).

In some examples, the latex polymer has a glass transition temperature (Tg) of up to about 100° C., for example up to about 95° C., up to about 90° C., up to about 80° C., up to about 75° C., up to about 70° C., or up to about 65° C. In some examples, the latex polymer has a glass transition temperature (Tg) of about 20° C. or greater, for example about 30° C. or greater, about 40° C. or greater, about 45° C. or greater, or about 50° C. or greater. In some examples, the latex polymer has a glass transition temperature in the range of about 20° C. to about 100° C., for example about 20° C. to about 80° C., or about 30° C. to about 70° C. The glass transition temperature (Tg) of the latex polymer may be determined using DSC (differential scanning calorimetry), for example determined according to ASTM D3418.

The latex polymer may be any latex polymer which may be provided in an aqueous dispersion. For example, the latex polymer may comprise an acrylic polymer (e.g. an acrylic copolymer).

The term “acrylic polymer” is used herein to refer to polymers/copolymers derived from acrylic based monomers, for example, acrylic acid monomers, methacrylic acid monomers, acrylate monomers, methacrylate monomers or combinations thereof.

Acrylic latex polymers may be formed from acrylic monomers and thus, may be said to comprise acrylic monomer residues or methacrylic monomer residues. Examples of monomers of the acrylic latex polymer include, by way of illustration and not limitation, acrylic monomers, such as, for example, acrylate esters, acrylamides, and acrylic acids, and methacrylic monomers, such as, for example, methacrylate esters, methacrylamides, and methacrylic acids. The acrylic latex polymer may be a homopolymer or copolymer of an acrylic monomer and another monomer such as, for example, a vinyl aromatic monomer including, but not limited to, styrene, styrene-butadiene, p-chloromethylstyrene, divinyl benzene, vinyl naphthalene and divinyl naphthalene, for example, such that, in some examples in accordance with the principles described herein, the acrylic latex polymer is a predominantly acrylic polymer. By “predominantly acrylic” is meant that the polymer contains greater than about 50%, or greater than about 55%, or greater than about 60%, or greater than about 70%, or greater than about 80%, or greater than about 90%, by weight, of copolymerized units comprising acrylic monomer residues or methacrylic monomer residues, or combinations thereof.

Examples of acrylate monomers include C₁ to C₃₀ alkyl acrylates (e.g. C₁ to C₂₀ alkyl acrylates, C₁ to C₁₀ alkyl acrylates, or C₁ to C₈ alkyl acrylates). In some examples, acrylate monomers may be selected from the group comprising methyl acrylate, ethyl acrylate, propyl acrylate, isopropyl acrylate, n-butyl acrylate, iso-butyl acrylate, tert- butyl acrylate, 2-ethylhexyl acrylate, lauryl acrylate, isobornyl acrylate, cyclohexyl acrylate, 3,3,5-trimethylcyclohexyl acrylate, isocane acrylate, glycidyl acrylate, 3,4-epoxycyclohexylmethylacrylate, 2-(3,4-epoxycyclohexyl)ethylacrylate, hydroxyethyl acrylate, hydroxypropyl acrylate, hydroxybutyl acrylate, methacrylic anhydride, diethyleneglycol bisacrylate, 4,4′-isopropylidenediphenolbisacrylate (Bisphenol A diacrylate), alkoxylated 4,4′-isopropylidenediphenol bisacrylate, trimethylolpropane trisacrylate and alkoxylated trimethylolpropane trisacrylate.

Examples of methacrylate monomers include C₁ to C₃₀ alkyl methacrylates (e.g. C₁ to C₂₀ alkyl methacrylates, C₁ to C₁₀ alkyl methacrylates, or C₁ to C₈ alkyl methacrylates), ethylene glycol methacrylates and dimethacrytales. In some examples, methacrylate monomers may be selected from the group comprising methyl methacrylate, ethyl methacrylate, propyl methacrylate, isopropyl methacrylate, n-butyl methacrylate, iso-butyl methacrylate, tert-butyl methacrylate, 2-ethylhexyl methacrylate, lauryl methacrylate, isobornyl methacrylate, cyclohexyl methacrylate, 3,3,5-trimethylcyclohexyl methacrylate, isocane methacrylate, glycidyl methacrylate, 3,4-epoxycyclohexylmethylmethacrylate, 2-(3,4-epoxycyclohexyl)ethylmethacrylate, hydroxyethyl methacrylate, hydroxypropyl methacrylate, hydroxybutyl methacrylate, methacrylic anhydride, diethyleneglycol bismethacrylate, 4,4′-isopropylidenediphenol bismethacrylate (Bisphenol A di methacrylate), alkoxylated 4,4′-isopropylidenediphenol bismethacrylate, trimethylolpropane trismethacrylate and alkoxylated trimethylolpropane trismethacrylate.

In some examples, the latex polymer comprises a (meth)acrylate polymer/copolymer. In some examples, the (meth)acrylate polymer/copolymer may be formed from monomers comprising C₁ to C₃₀ alkyl methacrylates (e.g. C₁ to C₂₀ alkyl methacrylates, C₁ to C₁₀ alkyl methacrylates, or C₁ to C₈ alkyl methacrylates), C₁ to C₃₀ alkyl acrylates (e.g. C₁ to C₂₀ alkyl acrylates, C₁ to C₁₀ alkyl acrylates, or C₁ to C₈ alkyl acrylates), ethylene glycol methacrylates, dimethacrytales, methacrylic acids, acrylic acids or combinations thereof.

In some examples, the latex polymer is formed from monomers selected from styrenes, C₁ to C₃₀ alkyl methacrylates (e.g. C₁ to C₂₀ alkyl methacrylates, C₁ to C₁₀ alkyl methacrylates, or C₁ to C₈ alkyl methacrylates), C₁ to C₃₀ alkyl acrylates (e.g. C₁ to C₂₀ alkyl acrylates, C₁ to C₁₀ alkyl acrylates, or C₁ to C₈ alkyl acrylates), ethylene glycol methacrylates, dimethacrytales, methacrylic acids, acrylic acids or combinations thereof.

In some examples, the latex polymer is a styrene-acrylic polymer. For example, the latex polymer may be formed from a styrene monomer and a monomer selected from acrylic acids, methacrylic acids, acrylates and methacrylates.

Examples of commercially available resins that may be used as to provide the latex polymer include: Joncryl 74-A™, Joncryl 77™, Joncryl 80™M, Joncryl 89™, Joncryl 537™, Joncryl 538™, Joncryl 585™, Joncryl 624™, Joncryl 660™ and Joncryl 631™, available from BASF™. Other non-limiting examples of resins or polymers that can be used to provide the latex polymer include acrylic resins available commercially from DSM™ Company under the names: NeoCryl® A-1 105, NeoCryl® A-1 110, NeoCryl® A-2082, NeoCryl® A-2099 and NeoCryl® A-2092; acrylic resins commercially available from Alberdingk-Boley™ Company under the names: Alberdingk® AC 2310, AlberdingkUSA® AC 2389, Alberdingk® AS 2065 VP; and acrylic resins commercially available from Dow™ Company under the names: UCAR™ Latex DL 420 G, UCAR™ Latex DL 424 and UCAR™ Latex DL 432 S.

In some examples, the latex polymer constitutes at least about 5 wt. % of the total solids content of the varnish composition, for example at least about 10 wt. %, at least about 15 wt. %, at least about 20 wt. %, at least about 25 wt. %, at least about 30 wt. %, at least about 40 wt. %, at least about 50 wt. %, at least about 55 wt. %, or at least about 60 wt. % of the total solids content of the varnish composition. In some examples, the latex polymer constitutes up to about 90 wt. % of the total solids content of the varnish composition, for example up to about 85 wt. %, up to about 80 wt. %, or up to about 75 wt. % the total solids content of the varnish composition. In some examples, the latex polymer constitutes from about 10 wt. % to about 85 wt. % of the total solids content of the varnish composition.

In some examples, the latex polymer is provided to a varnish composition in the form of a latex dispersion which may comprise latex polymer particles dispersed in water.

### Polymeric Salt

In some examples, the varnish composition comprises a polymeric salt. The polymeric salt may be derived from an acidic polymer, for example an acidic polymer having a weight averaged molecular weight Mw in the range of about 1000 to about 50 000.

As used herein, the term “polymeric salt” refers to a salt formed by the neutralisation of an acidic polymer by an alkali. The polymeric salt is soluble in water and therefore soluble in the varnish compositions described herein. On printing of the varnish compositions described herein, drying of the varnish composition by evaporation of the water and co-solvent leaves the polymeric salt in the varnish layer on the printed substrate.

An acidic polymer may be formed from a composition comprising acidic monomers. Acidic monomers that can be polymerized to form acidic polymers include, acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, combinations thereof, derivatives thereof, and mixtures thereof.

In some examples, the acidic polymer used to form the polymeric salt is formed from a composition comprising acidic monomers such as (meth)acrylic acid monomers. In some examples, the acidic polymer is an acrylic polymer.

In some examples, the acidic polymer is a copolymer formed from a composition comprising acidic monomers and a vinyl monomer. For example, the acidic polymer may be formed from acidic monomers and vinyl monomers selected from vinyl aromatic compounds (e.g. styrene), olefins (e.g. alkylene monomers such as ethylene and polypropylene), acrylates, methacrylates, acrylamides, methacrylamides and combinations thereof.

In some examples, the acidic polymer is a polymer formed from styrene and (meth)acrylic acid.

Examples of commercially available materials that may be used to provide the polymeric salt include Joncryl™ 50, Joncryl™ 60, Joncryl™ 61 , Joncryl™ 62, Joncryl™ 63, Joncryl™ ECO 75, Joncryl™ HPD 71 and Joncryl™ HPD 96 available from BASF™; and Neocryl™ BT-21 , Neocryl™ XK-39, Neocryl™ BT-107, Neocryl™ BT-24 available from DSM™.

In some examples, the acidic polymer has an acid number of greater than about 120 mg KOH/g, for example greater than about 150 mg KOH/g, greater than about 170 mg KOH/g, greater than about 180 mg KOH/g, or greater than about 200 mg KOH/g. In some examples, the acidic polymer has an acid number in the range of about 120 mg KOH/g to about 400 mg KOH/g, for example about 150 KOH/g to about 300 mg KOH/g. The acid number of a polymer, as measured in mg KOH/g can be measured using standard procedures known in the art, for example using the procedure described in ASTM D1386.

In some examples, the acidic polymer has a weight averaged molecular weight Mw of up to about 50 000, for example up to about 30 000, up to about 25 000, or up to about 20 000. In some examples, the acidic polymer has a weight averaged molecular weight Mw of greater than about 1000, for example greater than about 2000, or greater than about 5000. In some examples, the acidic polymer has a weight averaged molecular weight Mw in the range of about 1000 to about 50 000, for example about 1000 to about 25 000.

In some examples, the acidic polymers has an acid number of greater than about 120 mg KOH/g (for example greater than about 150 mg KOH/g, greater than about 170 mg KOH/g, greater than about 180 mg KOH/g, or greater than about 200 mg KOH/g) and a weight averaged molecular weight Mw of up to about 50 000 (for example up to about 30 000, up to about 25 000, or up to about 20 000).

The polymeric salt is formed by neutralising the acidic polymer with an alkali, such as neutralising the acidic polymer with a neutralising agent. Examples of neutralising agents include triethylamine (TEA), dimethyl ethanolamine (DMEA), triethanolamine, sodium salt, ammonia, ethyl diisopropyl amine (EDIPA). In some examples, the neutralising agent may be ammonia. In some examples, the polymeric salt is an alkylammonium polymeric salt.

In some examples, the jettable varnish composition comprises at least about 1 wt. % polymeric salt by total weight of the composition, for example at least about 2 wt. %, at least about 3 wt. %, or at least about 5 wt. % polymeric salt by the total weight of the varnish composition.

In some examples, the jettable varnish composition comprises up to about 25 wt. % polymeric salt by total weight of the composition, for example up to about 20 wt. %, up to about 15 wt. %, or up to about 10 wt. % polymeric salt by total weight of the varnish composition.

In some examples, the jettable varnish composition comprises from about 1 wt. % latex polymer to about 25 wt. % polymeric salt by total weight of the composition, for example about 2 wt. % to about 10 wt. % polymeric salt by total weight of the composition.

In some examples, the polymeric salt constitutes at least about 1 wt. % of the total solids content of the varnish composition, for example at least about 2 wt. %, at least about 5 wt. %, at least about 10 wt. %, at least about 15 wt. %, at least about 20 wt. %, at least about 25 wt. %, at least about 30 wt. %, at least about 35 wt. %, or at least about 40 wt. % of the total solids content of the varnish composition. In some examples, the polymeric salt constitutes up to about 50 wt. % of the total solids content of the varnish composition, for example up to about 45 wt. %, or up to about 40 wt. % the total solids content of the varnish composition. In some examples, the polymeric salt constitutes from about 5 wt. % to about 50 wt. % of the total solids content of the varnish composition.

### Co-Solvent

The co-solvent and water of the varnish composition may be described as the ‘liquid vehicle’ of the jettable varnish composition. In some examples, the liquid vehicle of the varnish composition comprises from about 50 wt. % to about 95 wt. %, for example from about 60 wt. % to about 90 wt. % of the composition by total weight of the composition. In some examples, the liquid vehicle comprises water and about 1 wt. % to about 70 wt. % organic co-solvent, for example water and about 5 wt. % to about 50 wt. % organic co-solvent.

In some examples, the varnish composition comprises at least about 2 wt. % co-solvent by total weight of the composition, for example at least 5 wt. %, at least about 10 wt. %, at least about 15 wt. %, or about 20 wt. % co-solvent by total weight of the composition. In some examples, the varnish composition comprises up to about 60 wt. % co-solvent by total weight of the composition, for example up to about 50 wt. %, up to about 40 wt. %, or up to about 30 wt. % co-solvent by total weight of the composition.

The co-solvent may be an organic solvent, for example a water-soluble organic solvent.

Examples of water-soluble organic co-solvents include: aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, co-solvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides.

In some examples, the co-solvent is selected from 1,5-pentanediol, 2-pyrrolidone, 2-ethyl-2-hydroxymethyl-1,3-propanediol, diethylene glycol, ethoxylated glycerol, 3-methoxybutanol, 1,3-dimethyl-2-imidazolidinone, or mixtures thereof.

In some examples, the co-solvent is selected from the group comprising diethylene glycol, dipropylene glycol, tetraethylene glycol, 1,5-pentanediol, 2-pyrrolidone, 2-methyl-2,4-pentanediol, 2-methyl-1,3-propanediol, 2-ethyl-2-hydroxymethyl-1,3-propanediol, 3-methoxybutanol, propylene glycol monobutyl ether, and 1,3-dimethyl imidazolidinone.

Co-solvents may be added to reduce the rate of evaporation of water in the varnish to minimize clogging or to adjust other properties of the ink such as viscosity, pH, and surface tension.

### Additives

The over-print varnish composition may also contain surfactants, waxes, buffering agents, biocides, viscosity modifiers, sequestering agents, stabilizing agents, humectants, and combinations thereof, as described earlier in connection with the fixer fluid composition and/or ink composition.

### Print Set

There is also described a print set comprising: a fixer fluid composition; an ink composition; and a latex-based over-print varnish composition.

In one example, the print set may be in the form of an inkjet printer cartridge or cartridges comprising printheads, each containing one of the compositions. In one example, each printhead may comprise a reservoir containing the respective composition. In one example, the fixer fluid composition may be as described herein. In one example, the ink composition may be as described herein. In one example, the latex-based over-print varnish composition may be as described herein. In one example, the print set is configured to be received by an inkjet printer, and operable to jet the fixer fluid composition, the ink composition and the latex-based over-print varnish composition onto a substrate.

The fixer fluid compositions described herein allow for the wet-on-wet application of latex-based over-print varnish compositions, such as those described herein, onto fixer and ink compositions printed on a substrate, whilst maintaining high gloss, durability and acceptable coalescence of the printed article. Furthermore, the present inventors have found that this can be achieved whilst the latex-based over-print varnish compositions can be digitally applied in a selective manner to a printed substrate, for example to leave areas without varnish. The substrate may then be subsequently dried, following application of all of the layers.

### EXAMPLES

The following illustrates examples of the compositions and related aspects described herein. Thus, these examples should not be considered to restrict the present disclosure but are merely in place to teach how to make examples of compositions of the present disclosure.

Fixer fluid compositions were formulated as shown in Tables 1 and 2.

TABLE 1

| | Formulation component | | | | | |
|---|---|---|---|---|---|---|
| | | | | Cationic | | |
| | | | | polymer | Total | |
| | Polyvalent metal salt | | | (50% | metal | |
| | (100% solids) | | | solids) | salt and | Ratio of |
| Formu- | Calcium | Calcium | Total | SNF | polymer | metal |
| lation | nitrate | propionate | metal salt | FL4150 | content | salt to |
| No. | (wt. %) | (wt. %) | (wt. %) | (wt. %) | (wt. %) | polymer |
| 1 | 8 | 2.8 | 10.8 | 0 | 10.8 | ∞ |
| 2 | 8 | 2.8 | 10.8 | 1.5 | 12.3 | 7.2:1 |
| 3 | 0 | 0 | 0 | 7 | 7 | 0:1 |
| 4 | 2 | 0.7 | 2.7 | 7 | 9.7 | 0.4:1 |
| 5 | 2 | 0.7 | 2.7 | 3 | 5.7 | 0.9:1 |
| 6 | 4 | 1.4 | 5.4 | 3 | 8.4 | 1.8:1 |
| 7 | 4 | 1.4 | 5.4 | 1.5 | 6.9 | 3.6:1 |

The following components completed the content of each formulation:

TABLE 2

| | Formulation component | | | | | |
|---|---|---|---|---|---|---|
| | Surfynol ® | Surfynol ® | Tetraethylene | Acticide ® | Acticide ® | |
| | SEF | CT-211 | glycol | B20 | M20 | Water |
| % solids | 100 | 100 | 100 | 100 | 100 | |
| Role in | Surfactant | Surfactant | Solvent- | Biocide | Biocide | Solvent |
| formulation | | | humectant | | | |
| wt. % in | 0.045 | 0.02 | 12 | 0.2 | 0.07 | Balance |
| formulation | | | | | | |

Each fixer fluid composition was printed using a thermal inkjet pen, Godzilla arch 8025, onto corrugated media (coated media: Pro WKL (Kemi art) Lite+, uncoated media: Royal 2000 CDP) at 1200×600 dpi (dots per inch) resolution with different dpp (drops per pixel). Black ink CV150 (for C500 HP PageWide press) was printed over the fixer layer using thermal inkjet pens, followed by application of a varnish layer using a piezo-electric inkjet head by Ricoh-MH2810F. Finally, the prints were dried using an IR dryer unit. At first fluid jettability was tested using the drop velocity tool and the drop weight tool, then the fluid was printed on the lab printer (Corgi) and the prints were evaluated for gloss, coalescence and durability.

The durability of the prints was tested using the Sutherland 2000 rub tester. Media prints were positioned under 4 libra weight with Melotex media attached. The prints were rubbed by the weight a certain amount of cycles according to the media type (500 cycles on coated media and 100 cycles on uncoated media). Prints after the test were graded from 1 to 5, where 1 is the worst (sample is very damaged) and 5 is the best (no noticeable damage). The gloss of the prints was measured using a Micro-gloss 75° by Gardner. The gloss was tested along the direction of print. The coalescence of the prints of different testing conditions was evaluated qualitatively using a proprietary automated image analysis to evaluate coalescence independently of granularity.

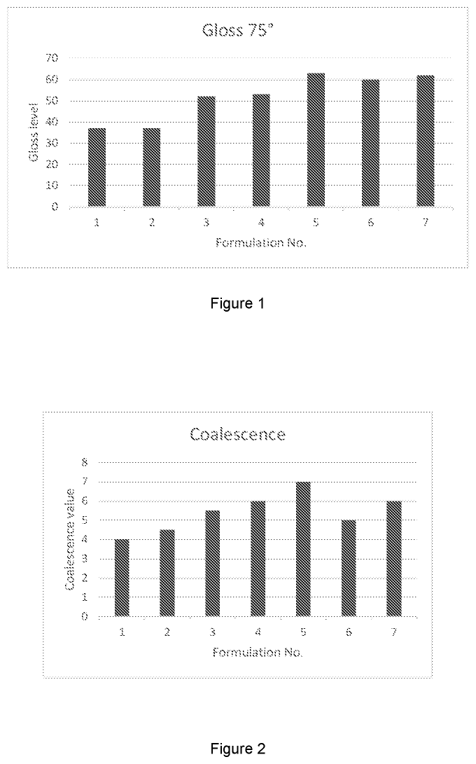

The results of these tests can be seen below in Table 3 and in FIGS. 1 and 2.

TABLE 3

| | Metal salt to | Gloss 75° (on | Coalescence value |
|---|---|---|---|
| Formulation | polymer ratio | black) | (on black) |
| 1 | ∞ | 37 | 4 |
| 2 | 7.2:1 | 37 | 4.5 |
| 3 | 0:1 | 52 | 5.5 |
| 4 | 0.4:1 | 53 | 6 |
| 5 | 0.9:1 | 63 | 7 |
| 6 | 1.8:1 | 60 | 5 |
| 7 | 3.6:1 | 62 | 6 |

As can be seen from FIGS. 1 and 2, formulation 6 demonstrated the best combined performance in gloss and coalescence. For example, formulation 1 demonstrates a better coalescence value, however, has much poorer gloss performance and conversely, formulation 5 demonstrates a superior gloss level compared to formulation 6, however, is far inferior in terms of coalescence—only formulation 6 has both high gloss and good coalescence performance. However, it can be seen that formulations 5 and 6 also have high gloss performance, but slightly poorer coalescence scores. Therefore, formulations with a ratio of metal salt to cationic polymer between the values of formulation 5 and 7 (i.e. 1:1 to 3.5:1) will also have a high gloss performance and acceptable coalescence values.

The performance of formulation 6 in a wet-on-wet (WOW) application method was then compared with its performance in a wet-on-dry (WOD) application method, with the results shown in Table 4.

TABLE 4
Fixer fluid formulation 6

| Test | Wet-on-wet application | Wet-on-dry application |
|---|---|---|
| Durability | Grade 5 | Grade 5 |
| Gloss 75° | 60 | 63 |
| Coalescence | 5 | 4.4 |

As can be seen, the wet-on-wet application method of a latex-based varnish layer affords comparable results with respect to the wet-on-dry application of a latex-based varnish layer when using fixer formulation 6. In view of these results, the performance of a reference fixer fluid (Formulation 1, including 0.095 wt % Tiron (CAS #149-45-1) was observed in the same test.

TABLE 5
Reference fixer fluid

| Test | Wet-on-wet application | Wet-on-dry application |
|---|---|---|
| Durability | Grade 3 | Grade 5 |
| Gloss 75° | 37 | 60 |
| Coalescence | 4.2 | 4.4 |

The results of the two compositions are shown in Table 5 and can thus be compared. The regular fixer fluid helps produce a printed article that has excellent durability, gloss and acceptable coalescence when a latex-based varnish is applied in a wet-on-dry method, however, the quality of the resultant printed article sharply declines when a latex-based varnish is applied in a wet-on-wet method to regular fixer fluid and ink compositions. Fixer formulation 6 on the other hand, performs consistently to a high level across the two application methods, affording printed articles with excellent durability, high gloss and good coalescence values. Comparing the wet-on-wet application performance of the two fixer formulations, the improvement of fixer formulation 6 is immediately apparent. The durability grade of the fixer formulation 6 is 2 higher than that of the regular fixer fluid (Grade 5 cf. Grade 3), the gloss of the printed article comprising the fixer formulation 6 is over 1.5 times better (60 cf. 37) and the coalescence is comparable (5 cf. 4.2).

The following tests were used to evaluate the jetting performance of the fixer formulations.

TOE, or Turn on Energy, determines the voltage (energy) needed to jet stable drops. The pen jets a fixed number of drops at a fixed frequency and a fixed temperature. The firing voltage changes from a high voltage (e.g. 35 volts) to a low voltage, and for each voltage interval a weight measurement is made. The test stops when the weight has decreased to less than 0.5 ng per nozzle. The result of the test is a graph of Drop weight behaviour as a function of energy. If the curve is stable in a range of energies (i.e. drop weight does not decrease), then jetting is considered stable at this range. The jetting voltage is set to the minimal voltage where the drop weight is stable, and this is the TOE set point.

The drop velocity is measured for several nozzles. Each nozzle jets several drops at a specific frequency. The drop passes through two laser beams, each laser beam a fixed distance from the other, with the time the drop taking to traverse said distance between the laser beams determining the velocity.

In order to determine the drop weight to frequency response (i.e. stability), a fixed number of drops are jetted onto a sensitive weight. The drop weight is measured at a different frequency varying from 2-40 kHz. If the drop weight does not decrease at the printing frequency, then the jetting is considered stable.

The decap test evaluates the jetting performance over time i.e. how long a printing nozzle may remain inactive before plugging. One way of determining decap is determining how many nozzles stop firing after a specific time interval during which the printhead remains idle (i.e. after a specific time interval over which none of the fixer, ink or varnish compositions are jetted from the nozzles of a printing apparatus, for example an inkjet printing apparatus). To test decap, an image is printed, the image print consists of lines in cross print direction. The lines are printed in different timing by different nozzles. Each part of the line printed represents a different decap timing. Decap score is set by the longest time delay between prints of lines (where the line is complete).

The following results were obtained for formulation 6 and the Reference.

TABLE 6

| Test | Formulation 6 | | Reference fixer | | Comments |
|---|---|---|---|---|---|
| Drop weight | ~6 | ng | ~5.8 | ng | |
| Drop velocity | 13.5 | m/sec | 11.8 | m/sec | |
| Stability | 1-26 | kHz | 1-30 | kHz | Freq at which DW |
| | | | | | stable |
| TOE (micro | 0.76 | mJ | 0.75 | mJ | Turn on energy |
| Joule) | | | | | |

| | | | |
|---|---|---|---|
| Decap | 1 sec | 1 sec | Idle time between |
| | open time | open time | recovery spit bar |
| | | | to print signature |
| | | | (intervals of 0.1 |
| | | | sec) |

As can be seen from the above results, whilst achieving improved gloss and durability over the regular fixer fluid, formulation 6 does not sacrifice any stability and in fact has comparable stability to regular fixer fluid, making it suitable for practical inkjet printing methods.

While the compositions, methods and related aspects have been described with reference to certain examples, it will be appreciated that various modifications, changes, omissions, and substitutions can be made without departing from the spirit of the disclosure. It is intended, therefore, that compositions, methods and related aspects be limited only by the scope of the following claims. Unless otherwise stated, the features of any dependent claim can be combined with the features of any of the other dependent claims, and any other independent claim.

1. A method of printing comprising:
applying a fixer composition onto a substrate the fixer composition comprising a polyvalent metal salt, a cationic polymer, and a liquid vehicle, wherein the ratio of polyvalent metal salt to cationic polymer is in a range of 1:1 to 3.5:1;
applying an ink composition onto the fixer composition; and
applying an over-print varnish composition onto the ink composition.

2. The method of claim 1, wherein the method is a wet-on-wet inkjet printing method.

3. The method of claim 1, wherein the polyvalent metal salt of the fixer composition comprises calcium propionate or calcium nitrate, or a mixture thereof.

4. The method of claim 3, wherein the ratio of calcium nitrate to calcium propionate is about 8:2.8.

5. The method of claim 1, wherein the cationic polymer is a polyamine.

6. The method of claim 1, wherein the cationic polymer is a polyethylenimine.

7. The method of claim 1, wherein the ratio of polyvalent metal salt to cationic polymer is about 1.8:1.

8. The method of claim 7, wherein the total content of polyvalent metal salt and cationic polymer in the fixer composition is up to 10 wt %.

9. The method of claim 1, wherein the liquid vehicle comprises an aqueous liquid vehicle.

10. The method of claim 1, wherein the over-print varnish composition comprises a latex-based or polyurethane dispersion-based over-print varnish composition.

11. The method of claim 1, wherein one or both of the fixer composition and the over-print varnish composition is applied by jetting the composition using an inkjet printer.

12. A printed article comprising:
a substrate;
a fixer composition disposed on the substrate, wherein the fixer composition comprises a polyvalent metal salt and a cationic polymer, wherein the ratio of polyvalent metal salt to cationic polymer is in a range of 1:1 to 3.5:1;
an ink composition disposed on the fixer composition; and
an over-print varnish composition disposed on the ink composition.

13. The printed article of claim 12, wherein the ratio of polyvalent metal salt to cationic polymer is in a range of 1.3:1 to 2.3:1, more preferably a ratio of about 1.8:1.

14. The printed article of claim 12, wherein the substrate comprises a paper-based substrate.

15. A print set comprising:
a fixer fluid composition comprising: a polyvalent metal salt, a cationic polymer, and a liquid vehicle; wherein the ratio of polyvalent metal salt to cationic polymer is in a range of 1:1 to 3.5:1;
an ink composition; and
an over-print varnish composition.
